(19) United States
(12) Patent Application Publication
(10) Pub. No.: US 2022/0019059 A1
(43) Pub. Date: Jan. 20, 2022

(54) IMAGING LENS AND IMAGING DEVICE

(71) Applicant: SONY GROUP CORPORATION, TOKYO (JP)

(72) Inventors: KENTA KAMEBUCHI, TOKYO (JP); MINORU TANIYAMA, KANAGAWA (JP); YASUHIDE NIHEI, TOKYO (JP)

(21) Appl. No.: 17/309,718

(22) PCT Filed: Nov. 25, 2019
(86) PCT No.: PCT/JP2019/045965

§ 371 Date: Jun. 16, 2021

(30) Foreign Application Priority Data
Dec. 26, 2018 (JP) 2018-243648

(51) Int. Cl. G02B 13/00; G02B 9/64; G02B 27/00; H04N 5/225

(52) U.S. Cl. CPC G02B 13/0045; H04N 5/2254; G02B 27/0025; G02B 9/64

(57) ABSTRACT

To achieve high performance. A first lens having a positive refractive power with a convex surface facing an object side, a second lens having a positive refractive power, a third lens having a negative refractive power, a fourth lens having a positive refractive power or a negative refractive power with a concave surface facing the object side, a fifth lens having a positive refractive power or a negative refractive power, a sixth lens having a positive refractive power with a concave surface facing an image side, and a seventh lens having a negative refractive power in the vicinity of an optical axis, a surface on the image side of which is formed into an aspherical shape having an inflection point are provided in order from the object side to the image side.

### TECHNICAL FIELD

The present technology relates to a technical field of an imaging lens including a plurality of lenses and an imaging device in which such imaging lens is used.

### BACKGROUND ART

As imaging devices such as digital still cameras, thin types such as card types have been widespread year after year, and they are required to be compact. Furthermore, imaging devices incorporated in mobile phones such as smartphones and mobile terminals such as tablets are also required to be thin in pursuit of design and to be compact for securing a space for multiple functions for differentiation. As a result, there is an increasing demand for making imaging lenses mounted on the imaging devices further compact.

Furthermore, as imaging elements such as a charge coupled device (CCD) and a complementary metal oxide semiconductor (CMOS) are made compact, the number of pixels is increasing due to miniaturization of a pixel pitch of the imaging elements, and high performance is also required in the imaging lenses used in the imaging devices accordingly.

Moreover, there is a demand for a large-diameter bright imaging lens that enables high-sensitivity imaging while preventing deterioration in image quality due to noise in imaging in a dark place.

Therefore, an imaging lens including a plurality of lenses is required as such a compact and high-performance imaging lens, and various types including five to seven lenses are suggested as an imaging lens including a plurality of lenses (refer to, for example, Patent Documents 1 to 3).

### CITATION LIST

### Patent Document

Patent Document 1: Japanese Patent Application Laid-Open No. 2010-262270
Patent Document 2: Japanese Patent Application Laid-Open No. 2018-66978
Patent Document 3: Japanese Patent Application Laid-Open No. 2014-145961

### SUMMARY OF THE INVENTION

### Problems to be Solved by the Invention

Patent Document 1 discloses an imaging lens including five lenses having high resolution, and realizes a response to a wide angle of view recently required with a half angle of view of 38 degrees.

However, a f-number is about 2.0 to 2.8, and in a case of trying to further reduce the f-number in the disclosed lens configuration, one positive lens on a most object side cannot sufficiently suppress an increase in spherical aberration due to an increase in diameter, so that it is difficult to satisfy both reduction in eccentric sensitivity and excellent optical performance.

Patent Document 2 discloses an imaging lens including six lenses having high resolution, and realizes a response to a wide angle of view recently required with a half angle of view of 39 to 45 degrees.

However, a f-number is about 1.8 to 2.3, and in a case of trying to further reduce the f-number in the disclosed lens configuration, one positive lens on a most object side cannot sufficiently suppress an increase in spherical aberration due to an increase in diameter, so that it is difficult to satisfy both reduction in eccentric sensitivity and excellent optical performance.

Patent Document 3 discloses an imaging lens including seven lenses having high resolution, and realizes a response to recent requirement of a low f-number such as the f-number of 1.6.

However, the half angle of view is about 32 degrees, and it is difficult to sufficiently respond to the wide angle of view recently required, by the disclosed lens configuration.

Therefore, an object of the imaging lens and imaging device of the present technology is to improve performance.

### Solutions to Problems

First, an imaging lens according to the present technology is provided with a first lens having a positive refractive power with a convex surface facing an object side, a second lens having a positive refractive power, a third lens having a negative refractive power, a fourth lens having a positive refractive power or a negative refractive power with a concave surface facing the object side, a fifth lens having a positive refractive power or a negative refractive power, a sixth lens having a positive refractive power with a concave surface facing an image side, and a seventh lens having a negative refractive power in the vicinity of an optical axis, a surface on the image side of which is formed into an aspherical shape having an inflection point, in order from the object side to the image side.

Therefore, an eccentric sensitivity is reduced and an aberration correction function is improved.

Second, it is desirable that the above-described imaging lens satisfy following conditional expression (1).

1.0<f1/f<225.0 (1)

where

f is a focal length of an entire system, and

f1 is a focal length of the first lens.

Therefore, the focal length of the first lens is optimized, and an appropriate refractive power with respect to an incident light beam may be obtained.

Third, it is desirable that the above-described imaging lens satisfy following conditional expression (2).

0.7<f2/f<4.0 (2)

where

f is a focal length of an entire system, and

f2 is a focal length of the second lens.

Therefore, the focal length of the second lens is optimized, and an appropriate refractive power with respect to an incident light beam may be obtained.

Fourth, it is desirable that the above-described imaging lens satisfy following conditional expression (3).

4.0<|f45|/f (3)

where

f is a focal length of an entire system, and

f45 is a composite focal length of the fourth and fifth lenses.

Therefore, the composite focal length of the fourth and fifth lenses is optimized, and an appropriate refractive power with respect to an incident light beam may be obtained.

Fifth, it is desirable that the above-described imaging lens satisfy following conditional expression (4).

2.8<f6/f<215.0 (4)

where

f is a focal length of an entire system, and

f6 is a focal length of the sixth lens.

Therefore, the focal length of the sixth lens is optimized, and an appropriate refractive power with respect to an incident light beam may be obtained.

Sixth, it is desirable that the above-described imaging lens satisfy following conditional expression (5).

−46.0<f6/f7<−0.3 (5)

where

f6 is a focal length of the sixth lens, and

f7 is a focal length of the seventh lens.

Therefore, the focal length of the sixth lens is optimized, and an appropriate refractive power with respect to an incident light beam may be obtained.

Seventh, it is desirable that the above-described imaging lens satisfy following conditional expression (6).

5.4<|R7/f|<220.0 (6)

where

f is a focal length of an entire system, and

R7 is a curvature radius of a surface on the object side of the fourth lens.

Therefore, the curvature radius of the surface on the object side of the fourth lens is optimized, and an appropriate refractive power of an air lens between the third lens and the fourth lens may be obtained.

Eighth, it is desirable that the above-described imaging lens satisfy following conditional expression (7).

5.8<|(R11+R12)/(R11−R12)|<320.0 (7)

where

R11 is a curvature radius of a surface on the object side of the sixth lens, and

R12 is a curvature radius of a surface on the image side of the sixth lens.

This makes it possible to sufficiently correct spherical aberration and higher-order aberration with respect to an off-axis light beam.

Ninth, it is desirable that the above-described imaging lens satisfy following conditional expression (8).

18.0<νd(L3)<νd(L5)<νd(L6)<30.0 (8)

where

νd (L3) is an Abbe number on a d-line of the third lens,

νd (L5) is an Abbe number on a d-line of the fifth lens, and

νd (L6) is an Abbe number on a d-line of the sixth lens.

This makes it possible to sufficiently correct axial chromatic aberration and magnification chromatic aberration.

Tenth, in the above-described imaging lens, it is desirable that an aperture diaphragm be arranged on the object side of the first lens or between the first lens and the second lens.

Therefore, the aperture diaphragm functions on the object side of the entire system.

Eleventh, in the above-described imaging lens, it is desirable that the sixth lens have an inflection point on a surface on the image side.

This makes it possible to have different aberration correction effects in the vicinity of the optical axis and outside the vicinity of the optical axis.

Twelfth, an imaging device according to the present technology is provided with an imaging lens and an imaging element that converts an optical image formed by the imaging lens into an electric signal, in which the imaging lens is provided with a first lens having a positive refractive power with a convex surface facing an object side, a second lens having a positive refractive power, a third lens having a negative refractive power, a fourth lens having a positive refractive power or a negative refractive power with a concave surface facing the object side, a fifth lens having a positive refractive power or a negative refractive power, a sixth lens having a positive refractive power with a concave surface facing an image side, and a seventh lens having a negative refractive power in the vicinity of an optical axis, a surface on the image side of which is formed into an aspherical shape having an inflection point, in order from the object side to the image side.

Therefore, the eccentric sensitivity is reduced and the aberration correction function is improved in the imaging lens.

### BRIEF DESCRIPTION OF DRAWINGS

FIG. 1 is a view illustrating an embodiment of an imaging lens and an imaging device of the present technology together with FIGS. 2 to 24, the view illustrating a lens configuration in a first embodiment of an imaging lens.

FIG. 2 is a view illustrating spherical aberration, astigmatism, and distortion aberration in a numerical value example in which specific numerical values are applied to the first embodiment.

FIG. 3 is a view illustrating a lens configuration in a second embodiment of an imaging lens.

FIG. 4 is a view illustrating spherical aberration, astigmatism, and distortion aberration in a numerical value example in which specific numerical values are applied to the second embodiment.

FIG. 5 is a view illustrating a lens configuration in a third embodiment of an imaging lens.

FIG. 6 is a view illustrating spherical aberration, astigmatism, and distortion aberration in a numerical value example in which specific numerical values are applied to the third embodiment.

FIG. 7 is a view illustrating a lens configuration in a fourth embodiment of an imaging lens.

FIG. 8 is a view illustrating spherical aberration, astigmatism, and distortion aberration in a numerical value example in which specific numerical values are applied to the fourth embodiment.

FIG. 9 is a view illustrating a lens configuration in a fifth embodiment of an imaging lens.

FIG. 10 is a view illustrating spherical aberration, astigmatism, and distortion aberration in a numerical value example in which specific numerical values are applied to the fifth embodiment.

FIG. 11 is a view illustrating a lens configuration in a sixth embodiment of an imaging lens.

FIG. 12 is a view illustrating spherical aberration, astigmatism, and distortion aberration in a numerical value example in which specific numerical values are applied to the sixth embodiment.

FIG. 13 is a view illustrating a lens configuration in a seventh embodiment of an imaging lens.

FIG. 14 is a view illustrating spherical aberration, astigmatism, and distortion aberration in a numerical value example in which specific numerical values are applied to the seventh embodiment.

FIG. 15 is a view illustrating a lens configuration in an eighth embodiment of an imaging lens.

FIG. 16 is a view illustrating spherical aberration, astigmatism, and distortion aberration in a numerical value example in which specific numerical values are applied to the eighth embodiment.

FIG. 17 is a view illustrating a lens configuration in a ninth embodiment of an imaging lens.

FIG. 18 is a view illustrating spherical aberration, astigmatism, and distortion aberration in a numerical value example in which specific numerical values are applied to the ninth embodiment.

FIG. 19 is a view illustrating a lens configuration in a tenth embodiment of an imaging lens.

FIG. 20 is a view illustrating spherical aberration, astigmatism, and distortion aberration in a numerical value example in which specific numerical values are applied to the tenth embodiment.

FIG. 21 is a block diagram illustrating an example of an imaging device.

FIG. 22 is a block diagram illustrating a schematic configuration example of an in-vivo information obtaining system.

FIG. 23 is a block diagram illustrating a schematic configuration example of a vehicle control system.

FIG. 24 is an illustrative view illustrating an example of installation positions of a vehicle exterior information detection unit and an imaging unit.

### MODE FOR CARRYING OUT THE INVENTION

A mode for carrying out an imaging lens and an imaging device according to the present technology is hereinafter described.

### [Configuration of Imaging Lens]

The imaging lens of the present technology is provided with a first lens having a positive refractive power with a convex surface facing an object side, a second lens having a positive refractive power, a third lens having a negative refractive power, a fourth lens having a positive refractive power or a negative refractive power with a concave surface facing the object side, a fifth lens having a positive refractive power or a negative refractive power, a sixth lens having a positive refractive power with a concave surface facing an image side, and a seventh lens having a negative refractive power in the vicinity of an optical axis, a surface on the image side of which is formed into an aspherical shape having an inflection point in order from the object side to the image side.

In this manner, the imaging lens has a lens configuration of seven lenses in total, each lens arranged to have an optimal refractive power and formed into a lens shape in which an aspheric surface is effectively used, so that it becomes possible to excellently correct various aberrations while securing a large diameter and miniaturization and improve performance.

Furthermore, regarding each lens, it becomes possible to correct the various aberrations more excellently while securing the large diameter and miniaturization by combining optimum glass materials.

Especially, by forming the surface on the object side of the fourth lens into a concave shape, it is possible to excellently correct coma aberration and field curvature while reducing an eccentric sensitivity.

### [Configuration of Imaging Lens According to One Embodiment]

It is desirable that following conditional expression (1) be satisfied in an imaging lens according to one embodiment of the present technology.

1.0<f1/f<225.0 (1)

where

f is a focal length of an entire system, and

f1 is a focal length of the first lens.

Conditional expression (1) is an expression that defines a ratio between the focal length of the first lens and the focal length of the entire system.

If it exceeds an upper limit of conditional expression (1), the focal length of the first lens becomes long and the refractive power with respect to an incident light beam becomes weak, so that it becomes difficult to achieve miniaturization because of a long entire length of the lens.

On the other hand, if it exceeds a lower limit of conditional expression (1), the focal length of the first lens becomes short and the refractive power with respect to the incident light beam becomes strong, so that the miniaturization may be achieved and the coma aberration may be easily corrected; however, the eccentric sensitivity at the time of lens assembly increases.

Therefore, by satisfying conditional expression (1), it is possible to reduce the eccentric sensitivity at the time of assembly of the lens while securing the miniaturization, and secure an excellent optical performance.

Furthermore, in order to further improve the above-described effect, it is desirable that a range of conditional expression (1) be set to a range of following conditional expression (1)′.

2.45<f1/f<43.50 (1)′

where

f is a focal length of an entire system, and

f1 is a focal length of the first lens.

It is desirable that following conditional expression (2) be satisfied in the imaging lens according to one embodiment of the present technology.

0.7<f2/f<4.0 (2)

where

f is a focal length of an entire system, and

f2 is a focal length of the second lens.

Conditional expression (2) is an expression that defines a ratio between the focal length of the second lens and the focal length of the entire system.

If it exceeds an upper limit of conditional expression (2), the focal length of the second lens becomes long and the refractive power with respect to the incident light beam becomes weak, so that it becomes difficult to achieve the miniaturization because of the long entire length of the lens.

On the other hand, if it exceeds a lower limit of conditional expression (2), the focal length of the second lens becomes short and the refractive power with respect to the incident light beam becomes strong, so that the miniaturization may be achieved and the coma aberration may be easily corrected; however, the eccentric sensitivity at the time of lens assembly increases.

Therefore, by satisfying conditional expression (2), it is possible to reduce the eccentric sensitivity at the time of lens assembly while securing the miniaturization, and secure the excellent optical performance.

Furthermore, in order to further improve the above-described effect, it is desirable that a range of conditional expression (2) be set to a range of following conditional expression (2)′.

0.78<f2/f<1.23 (2)′

where

f is a focal length of an entire system, and

f2 is a focal length of the second lens.

It is desirable that following conditional expression (3) be satisfied in the imaging lens according to one embodiment of the present technology.

4.0<|f45|/f (3)

where

f is a focal length of an entire system, and

f45 is a composite focal length of the fourth and fifth lenses.

Conditional expression (3) is an expression that defines a ratio between the composite focal length of the fourth and fifth lenses and the focal length of the entire system.

If it exceeds a lower limit of conditional expression (3), the composite focal length of the fourth and fifth lenses becomes short and the refractive power with respect to the incident light beam becomes strong, so that the miniaturization may be achieved and the coma aberration may be easily corrected; however, the eccentric sensitivity at the time of lens assembly increases.

Therefore, by satisfying conditional expression (3), it is possible to reduce the eccentric sensitivity at the time of lens assembly while securing the miniaturization, and secure the excellent optical performance.

Furthermore, in order to further improve the above-described effect, it is desirable that a range of conditional expression (3) be set to a range of following conditional expression (3)′.

4.04<|f45|/f<42.63 (3)′

where

f is a focal length of an entire system, and

f45 is a composite focal length of the fourth and fifth lenses.

It is desirable that following conditional expression (4) be satisfied in the imaging lens according to one embodiment of the present technology.

2.8<f6/f<215.0 (4)

where

f is a focal length of an entire system, and

f6 is a focal length of the sixth lens.

Conditional expression (4) is an expression that defines a ratio between the focal length of the sixth lens and the focal length of the entire system.

If it exceeds an upper limit of conditional expression (4), the focal length of the sixth lens becomes long and the refractive power with respect to the incident light beam becomes weak, so that it becomes difficult to achieve the miniaturization because of the long entire length of the lens.

On the other hand, if it exceeds a lower limit of conditional expression (4), the focal length of the sixth lens becomes short and the refractive power with respect to the incident light beam becomes strong, so that the miniaturization may be achieved and the coma aberration may be easily corrected; however, back focus becomes too short and it becomes difficult to secure a space for arranging an infrared cut filter and the like.

Therefore, by satisfying conditional expression (4), it is possible to elongate the back focus to secure a sufficient space for arranging the infrared cut filter and the like while securing the miniaturization, and secure the excellent optical performance.

Furthermore, in order to further improve the above-described effect, it is desirable that a range of conditional expression (4) be set to a range of following conditional expression (4)′.

2.87<f6/f<133.14 (4)′

where

f is a focal length of an entire system, and

f6 is a focal length of the sixth lens.

It is desirable that following conditional expression (5) be satisfied in the imaging lens according to one embodiment of the present technology.

−46.0<f6/f7<−0.3 (5)

where

f6 is a focal length of the sixth lens, and

f7 is a focal length of the seventh lens.

Conditional expression (5) is an expression that defines a ratio between the focal length of the sixth lens and the focal length of the seventh lens.

If it exceeds a lower limit of conditional expression (5), the focal length of the sixth lens becomes long and the refractive power with respect to the incident light beam becomes weak, so that it becomes difficult to achieve the miniaturization because of the long entire length of the lens.

On the other hand, if it exceeds an upper limit of conditional expression (5), the focal length of the sixth lens becomes short and the refractive power with respect to the incident light beam becomes strong, so that the miniaturization may be achieved and the coma aberration may be easily corrected; however, the back focus becomes too short and it becomes difficult to secure the space for arranging the infrared cut filter and the like.

Therefore, by satisfying conditional expression (5), it is possible to elongate the back focus to secure a sufficient space for arranging the infrared cut filter and the like while securing the miniaturization, and secure the excellent optical performance.

Furthermore, in order to further improve the above-described effect, it is desirable that a range of conditional expression (5) be set to a range of following conditional expression (5)′.

−21.62<f6/f7<−0.35 (5)′

where

f6 is a focal length of the sixth lens, and

f7 is a focal length of the seventh lens.

It is desirable that following conditional expression (6) be satisfied in the imaging lens according to one embodiment of the present technology.

5.4<|R7/f|<220.0 (6)

where

f is a focal length of an entire system, and

R7 is a curvature radius of a surface on the object side of the fourth lens.

Conditional expression (6) is an expression that defines a ratio between the curvature radius of the surface on the object side of the fourth lens and the focal length of the entire system.

If it exceeds an upper limit of conditional expression (6), the curvature radius of the surface on the object side of the fourth lens becomes large and a refractive power of an air lens between the third and fourth lenses becomes weak, so that an angle at which the light beam is flipped up becomes small and the entire length of the lens becomes long, and it becomes difficult to achieve the miniaturization.

On the other hand, if it exceeds a lower limit of conditional expression (6), the curvature radius of the surface on the object side of the fourth lens becomes small and the refractive power of the air lens between the third and fourth lenses becomes strong, so that the angle at which the light beam is flipped up becomes large, and it becomes difficult to correct the coma aberration and field curvature.

Therefore, by satisfying conditional expression (6), it is possible to improve an effect of correcting the coma aberration and field curvature while securing the miniaturization, and secure the excellent optical performance.

Furthermore, in order to further improve the above-described effect, it is desirable that a range of conditional expression (6) be set to a range of following conditional expression (6)′.

17.07<|R7/f|<218.52 (6)′

where

f is a focal length of an entire system, and

R7 is a curvature radius of a surface on the object side of the fourth lens.

It is desirable that following conditional expression (7) be satisfied in the imaging lens according to one embodiment of the present technology.

5.8<|(R11+R12)/(R11−R12)|<320.0 (7)

where

R11 is a curvature radius of a surface on the object side of the sixth lens, and

R12 is a curvature radius of a surface on the image side of the sixth lens.

Conditional expression (7) is an expression that defines a shape of a paraxial curvature radius of the surface on the object side of the sixth lens and the surface on the image side of the sixth lens.

If it exceeds an upper or lower limit of conditional expression (7), it becomes difficult to sufficiently correct spherical aberration and high-order aberration with respect to an off-axis light beam.

Therefore, by satisfying conditional expression (7), it is possible to sufficiently correct the spherical aberration and the high-order aberration with respect to the off-axis light beam, and secure the excellent optical performance.

Furthermore, in order to further improve the above-described effect, it is desirable that a range of conditional expression (7) be set to a range of following conditional expression (7)′.

5.87<|(R11+R12)/(R11−R12)|<38.63 (7)′

where

R11 is a curvature radius of a surface on the object side of the sixth lens, and

R12 is a curvature radius of a surface on the image side of the sixth lens.

It is desirable that following conditional expression (8) be satisfied in the imaging lens according to one embodiment of the present technology.

18.0<νd(L3)<νd(L5)<νd(L6)<30.0 (8)

where

νd (L3) is an Abbe number on a d-line of the third lens,

νd (L5) is an Abbe number on a d-line of the fifth lens, and

νd (L6) is an Abbe number on a d-line of the sixth lens.

Conditional expression (8) is an expression that defines magnitudes of the Abbe number of the third lens, the Abbe number of the fifth lens, and the Abbe number of the sixth lens.

If it exceeds an upper or lower limit of conditional expression (8), it becomes difficult to sufficiently correct axial chromatic aberration and magnification chromatic aberration.

Therefore, by satisfying conditional expression (8), it is possible to sufficiently correct the axial chromatic aberration and the magnification chromatic aberration, and secure the excellent optical performance.

In the imaging lens according to one embodiment of the present technology, it is desirable that an aperture diaphragm be arranged on the object side of the first lens or between the first lens and the second lens.

By arranging the aperture diaphragm on the object side of the first lens or between the first lens and the second lens, the aperture diaphragm functions on the object side of the entire system, and it is possible to make an amount light incident on the first lens or the second lens appropriate and secure the excellent optical performance.

It is desirable that the sixth lens have an inflection point on the surface on the image side in the imaging lens according to one embodiment of the present technology.

By having the inflection point on the surface on the image side of the sixth lens, it is possible to provide different aberration correction effects in the vicinity of an optical axis and outside the vicinity of the optical axis, and secure the excellent optical performance. Especially, by making a shape in the vicinity of the optical axis of the sixth lens a concave shape and making a shape in a peripheral portion a convex shape, it is possible to secure the excellent optical performance and suppress an incident angle on the image surface of the light.

### [Numerical Value Example of Imaging Lens]

Hereinafter, a specific embodiment of the imaging lens of the present technology and a numerical value example in which specific numerical values are applied to the embodiment are described with reference to drawings and tables.

Note that, the meanings of the symbols and the like in the following respective tables and descriptions are as described below.

When a surface number of the lens and the like is set to i, “R” represents a paraxial curvature radius of an i-th surface, “T” represents an on-axis surface spacing between the i-th surface and an (i+1)-th surface (a thickness of the lens center or an air interval), “refractive index” represents a refractive index on the d-line (λ=587.6 nm) of the lens and the like starting from the i-th surface, and “Abbe number” represents the Abbe number on the d-line of the lens and the like starting from the i-th surface.

In a “lens” field, “L1, L2, . . . ” represent the first lens, the second lens, . . . , respectively, “R1” represents the surface on the object side, and “R2” represents the surface on the image side. Regarding “R”, “infinity” represents that the surface is a flat surface.

“Focal length” represents the focal length of the entire optical system, “f-number” represents an f-number, “total length” represents the total length of the entire optical system, and “ω” represents a half angle of view.

Note that, in each table illustrating aspherical coefficients as follows, “E-n” is an exponential representation with a base of 10, that is, “n-minex”, and for example, “0.12345E-05” represents “0.12345×(10 to the negative fifth power)”.

Some of the imaging lenses used in each embodiment includes a lens surface formed into an aspherical surface. The aspherical shape is defined by following mathematical expression 1, where “x” is a distance (sag amount) from an apex of the lens surface in an optical axis direction, “y” is a height (image height) in a direction orthogonal to the optical axis direction, “c” is a paraxial curvature at the apex of the lens (reciprocal of the curvature radius), “K” is a conic constant, and “A”, “B”, are fourth, sixth, . . . , aspherical coefficients, respectively.

x=cy²/[1+{1−(1+κ)c²y²}^{1/2}]+Ay⁴+By⁶+ [Mathematical Expression 1]

Note that, in each example, the aperture diaphragm is represented as “diaphragm” to the right of the surface number, and a seal glass is represented as “SG” to the right of the surface number.

### First Embodiment

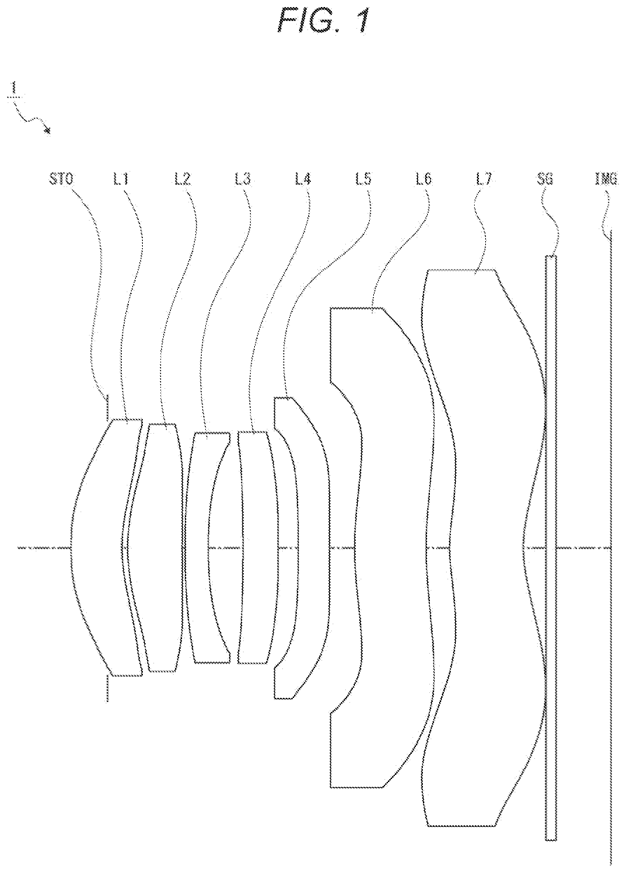

FIG. 1 illustrates a lens configuration of an imaging lens 1 in a first embodiment of the present technology.

The imaging lens 1 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 1 illustrates lens data of a numerical value example 1 in which specific numerical values are applied to the imaging lens 1.

TABLE 1

| SURFACE | | | | REFRACTIVE | ABBE |
|---|---|---|---|---|---|
| NUMBER | LENS | R | T | INDEX | NUMBER |
| 1 | | INFINITY | 0.390 | | |
| 2 | DIAPHRAGM | INFINITY | −0.390 | | |
| 3 | L1R1 | 2.079 | 0.547 | 1.544 | 56.1 |
| 4 | L1R2 | 1.922 | 0.054 | | |
| 5 | L2R1 | 1.825 | 0.591 | 1.544 | 56.1 |
| 6 | L2R2 | 26.038 | 0.030 | | |
| 7 | L3R1 | 9.050 | 0.250 | 1.671 | 19.2 |
| 8 | L3R2 | 3.783 | 0.375 | | |
| 9 | L4R1 | −78.500 | 0.374 | 1.544 | 56.1 |
| 10 | L4R2 | −13.452 | 0.219 | | |
| 11 | L5R1 | −46.912 | 0.337 | 1.644 | 22.5 |
| 12 | L5R2 | 25.810 | 0.272 | | |
| 13 | L6R1 | 4.715 | 0.767 | 1.616 | 25.8 |
| 14 | L6R2 | 4.477 | 0.250 | | |
| 15 | L7R1 | 2.213 | 0.793 | 1.535 | 55.7 |
| 16 | L7R2 | 1.690 | 0.240 | | |
| 17 | SG | INFINITY | 0.110 | 1.517 | 64.2 |
| 18 | | INFINITY | 0.550 | | |
| 19 | IMAGE | INFINITY | 0.046 | | |
| | SURFACE | | | | |

The aspherical coefficient and the like of each surface of the lens in the numerical value example 1 are illustrated in Tables 2-1 and 2-2 together with a conic constant K.

TABLE 2-1

| SURFACE NUMBER | 3 | 4 | 5 | 6 |
|---|---|---|---|---|
| Y CURVATURE RADIUS R | 2.079 | 1.922 | 1.825 | 26.038 |
| NORMALIZED RADIUS | 0.0000E+00 | 0.0000E+00 | 0.0000E+00 | 0.0000E+00 |
| CONIC CONSTANT K | −1.5586E−02 | −5.5963E+00 | −5.4656E+00 | −1.0000E+01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.5624E−02 | −5.7314E−02 | −2.5635E−02 | −5.5320E−02 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −2.8880E−03 | 7.7091E−03 | −2.3622E−02 | 1.2023E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 5.1192E−03 | −2.9943E−02 | −8.9598E−03 | −1.8671E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.4317E−03 | 3.4594E−02 | 1.9381E−02 | 1.3091E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.7065E−03 | −1.4153E−02 | −4.7407E−03 | −4.3469E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 2.5337E−03 | 0.0000E+00 | 5.4664E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 9.050 | 3.783 | −78.500 |
| NORMALIZED RADIUS | 0.0000E+00 | 0.0000E+00 | 0.0000E+00 |
| CONIC CONSTANT K | 1.0000E+01 | −5.6531E−01 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −4.4476E−02 | −1.2872E−03 | −2.1849E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 1.4467E−01 | 6.2601E−02 | −1.6910E−03 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −1.8770E−01 | −8.7391E−02 | −1.3202E−03 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1893E−01 | 6.9920E−02 | −6.1796E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3665E−02 | −2.9904E−02 | 5.4800E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.4059E−03 | 6.7355E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 1.9946E−05 | 7.4849E−05 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 2-2

| SURFACE NUMBER | 10 | 11 | 12 | 13 |
|---|---|---|---|---|
| Y CURVATURE RADIUS R | −13.452 | −46.912 | 25.810 | 4.715 |
| NORMALIZED RADIUS | 0.0000E+00 | 0.0000E+00 | 0.0000E+00 | 0.00000+00 |
| CONIC CONSTANT K | 0.0000E+00 | 1.0000E+01 | −1.0000E+01 | 3.4092E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.0634E−01 | −3.4480E−02 | 4.6492E−03 |
| FOURTH-ORDER ASPHERIC COEFFICIENT | −1.9461E−02 | 4.0224E−01 | 3.3356E−02 | −1.6961E−02 |
| FIFTH-ORDER ASPHERIC COEFFICIENT | 0.0000E+00 | −9.5838E−01 | 4.5641E−02 | 1.3233E−02 |
| SIXTH-ORDER ASPHERIC COEFFICIENT | 4.5810E−03 | 1.3920E+00 | −4.7838E−01 | −7.0586E−02 |
| SEVENTH-ORDER ASPHERIC COEFFICIENT | 0.0000E+00 | −2.2943E+00 | 6.1757E−01 | 3.2798E−02 |
| EIGHTH-ORDER ASPHERIC COEFFICIENT | −1.3307E−02 | 4.0666E+00 | −2.0436E−01 | −4.4998E−03 |
| NINTH-ORDER ASPHERIC COEFFICIENT | 0.0000E+00 | −4.4392E+00 | −6.4083E−02 | 1.6753E−02 |
| TENTH-ORDER ASPHERIC COEFFICIENT | 2.2203E−04 | 1.7060E+00 | −5.0765E−02 | −1.2342E−02 |
| 11TH-ORDER ASPHERIC COEFFICIENT | 0.0000E+00 | 9.1654E−01 | 8.6067E−02 | −2.8422E−03 |
| 12TH-ORDER ASPHERIC COEFFICIENT | 3.0224E−03 | −7.2293E−01 | 1.2872E−02 | 3.3436E−03 |
| 13TH-ORDER ASPHERIC COEFFICIENT | 0.0000E+00 | −2.0898E−01 | −3.0044E−02 | −7.7520E−05 |
| 14TH-ORDER ASPHERIC COEFFICIENT | 0.0000E+00 | 1.3008E−01 | −7.0547E−03 | −2.2738E−04 |
| 15TH-ORDER ASPHERIC COEFFICIENT | 0.0000E+00 | 1.0808E−01 | 1.2855E−02 | 2.0966E−05 |
| 16TH-ORDER ASPHERIC COEFFICIENT | 0.0000E+00 | −5.1410E−02 | −3.1059E−03 | 2.5021E−06 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.477 | 2.213 | 1.690 |
| NORMALIZED RADIUS | 0.0000E+00 | 0.0000E+00 | 0.0000E+00 |
| CONIC CONSTANT K | 1.8449E+00 | −5.5639E−01 | −1.1953E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.2180E−02 | −4.3821E−02 | 1.3764E−02 |
| FOURTH-ORDER ASPHERIC COEFFICIENT | −7.5296E−02 | −2.0994E−01 | −2.3769E−01 |
| FIFTH-ORDER ASPHERIC COEFFICIENT | 1.4240E−01 | 8.4908E−02 | 1.2805E−01 |
| SIXTH-ORDER ASPHERIC COEFFICIENT | −1.1062E−01 | 9.6938E−03 | 1.8057E−04 |
| SEVENTH-ORDER ASPHERIC COEFFICIENT | 2.5313E−02 | −4.7267E−03 | −2.0642E−02 |
| EIGHTH-ORDER ASPHERIC COEFFICIENT | 4.6249E−03 | −2.8698E−03 | 4.7641E−03 |
| NINTH-ORDER ASPHERIC COEFFICIENT | −1.8221E−03 | 7.7055E−04 | 3.6762E−04 |
| TENTH-ORDER ASPHERIC COEFFICIENT | 1.5811E−04 | 2.8621E−04 | −3.8465E−06 |
| 11TH-ORDER ASPHERIC COEFFICIENT | −1.2661E−04 | −4.1894E−05 | −3.8064E−05 |
| 12TH-ORDER ASPHERIC COEFFICIENT | −1.0280E−04 | −3.3919E−05 | −2.1105E−05 |
| 13TH-ORDER ASPHERIC COEFFICIENT | 4.5365E−05 | 5.3588E−08 | 4.8397E−06 |
| 14TH-ORDER ASPHERIC COEFFICIENT | 1.5831E−05 | 1.8148E−06 | 1.0320E−06 |
| 15TH-ORDER ASPHERIC COEFFICIENT | −5.7084E−06 | 6.2146E−07 | −1.1859E−07 |
| 16TH-ORDER ASPHERIC COEFFICIENT | −4.8116E−08 | −1.7960E−07 | −2.5912E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 1 are illustrated in Table 3.

TABLE 3

| | |
|---|---|
| FOCAL LENGTH | 4.60 |
| F-NUMBER | 1.6 |
| TOTAL LENGTH | 5.804 |
| ω | 39.8 |

A focal length of each lens in the numerical value example 1 is illustrated in Table 4.

TABLE 4

| | FOCAL LENGTH |
|---|---|
| L1 | 200.10 |
| L2 | 3.57 |
| L3 | −9.76 |
| L4 | 29.70 |
| L5 | −25.53 |
| L6 | 612.46 |
| L7 | −28.33 |

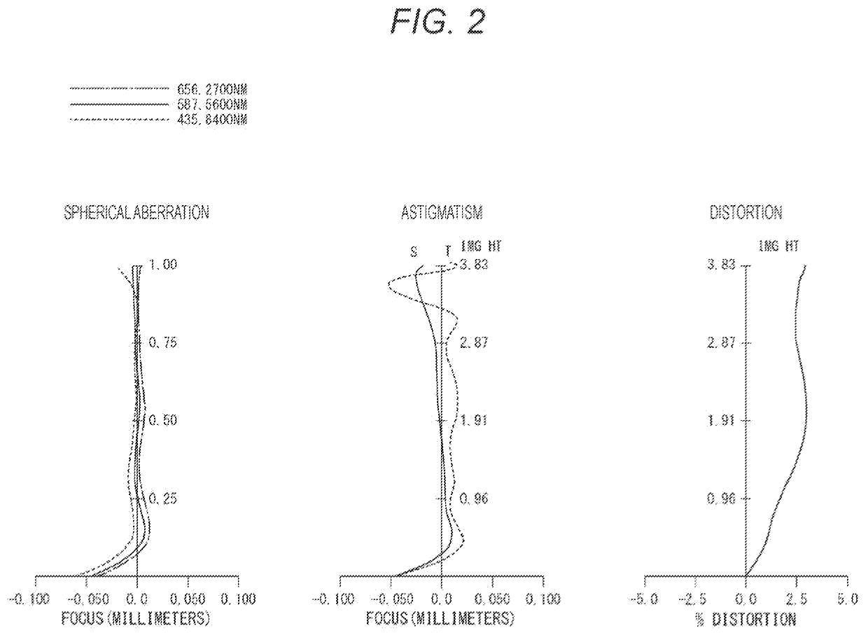

FIG. 2 is an aberration diagram of the numerical value example 1. In FIG. 2, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 1, and this has an excellent image forming performance.

### Second Embodiment

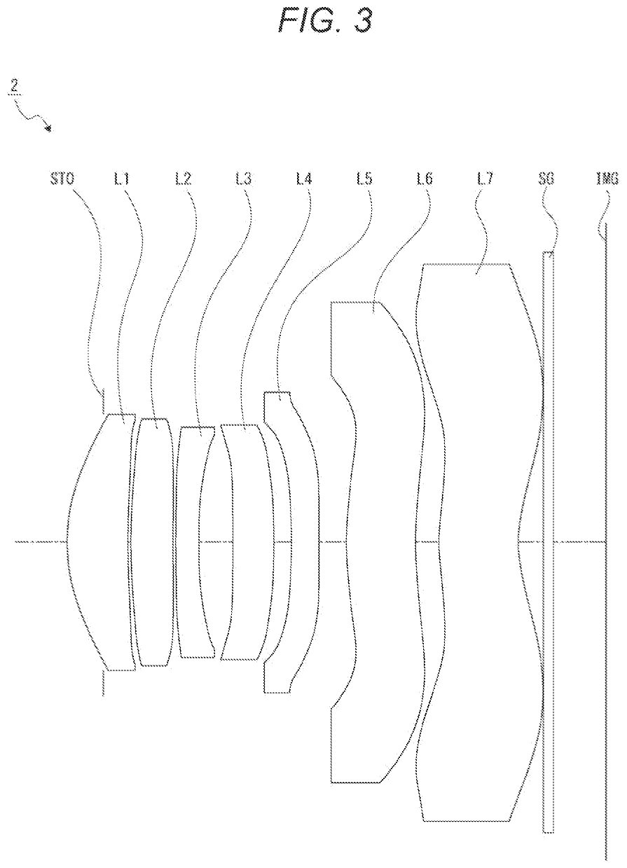

FIG. 3 illustrates a lens configuration of an imaging lens 2 in a second embodiment of the present technology.

The imaging lens 2 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 5 illustrates lens data of a numerical value example 2 in which specific numerical values are applied to the imaging lens 2.

TABLE 5

| SURFACE | | | | REFRACTIVE | ABBE |
|---|---|---|---|---|---|
| NUMBER | LENS | R | T | INDEX | NUMBER |
| 1 | | INFINITY | 0.390 | | |
| 2 | DIAPHRAGM | INFINITY | −0.390 | | |
| 3 | L1R1 | 2.141 | 0.650 | 1.544 | 56.1 |
| 4 | L1R2 | 8.886 | 0.030 | | |
| 5 | L2R1 | 6.800 | 0.457 | 1.544 | 56.1 |
| 6 | L2R2 | 22.251 | 0.030 | | |
| 7 | L3R1 | 27.427 | 0.250 | 1.671 | 19.2 |
| 8 | L3R2 | 5.945 | 0.368 | | |
| 9 | L4R1 | −49.500 | 0.441 | 1.544 | 56.1 |
| 10 | L4R2 | −8.359 | 0.190 | | |
| 11 | L5R1 | −8.382 | 0.298 | 1.644 | 22.5 |
| 12 | L5R2 | −46.453 | 0.294 | | |
| 13 | L6R1 | 4.523 | 0.746 | 1.616 | 25.8 |
| 14 | L6R2 | 4.552 | 0.253 | | |
| 15 | L7R1 | 2.236 | 0.856 | 1.535 | 55.7 |
| 16 | L7R2 | 1.654 | 0.268 | | |
| 17 | SG | INFINITY | 0.110 | 1.517 | 64.2 |
| 18 | | INFINITY | 0.550 | | |
| 19 | IMAGE | INFINITY | 0.017 | | |
| | SURFACE | | | | |

The aspherical coefficient and the like of each surface of the lens in the numerical value example 2 are illustrated in Tables 6-1 and 6-2 together with a conic constant K.

TABLE 6-1

| SURFACE NUMBER | 3 | 4 | 5 | 6 |
|---|---|---|---|---|
| Y CURVATURE RADIUS R | 2.141 | 8.886 | 6.800 | 22.251 |
| NORMALIZED RADIUS | 0.0000E+00 | 0.0000E+00 | 0.0000E+00 | 0.0000E+00 |
| CONIC CONSTANT K | 8.1091E−02 | 1.0000E+01 | −2.5961E+00 | 1.0000E+01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −7.4441E−03 | −2.4904E−02 | −1.3121E−02 | −5.2365E−02 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −4.4471E−03 | 5.8559E−03 | −8.4830E−03 | 1.1807E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 3.9654E−03 | −3.0074E−02 | −8.2356E−03 | −1.8594E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.4909E−03 | 3.4763E−02 | 1.7951E−02 | 1.3139E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.8966E−03 | −1.4351E−02 | −5.2321E−03 | −4.3871E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 2.5337E−03 | 0.0000E+00 | 5.4664E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 27.427 | 5.945 | −49.500 |
| NORMALIZED RADIUS | 0.0000E+00 | 0.0000E+00 | 0.0000E+00 |
| CONIC CONSTANT K | −1.0000E+01 | −6.8337E+00 | 1.0000E+01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −4.1833E−02 | −5.3722E−03 | −3.8169E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 1.4364E−01 | 6.7765E−02 | −2.2557E−03 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −1.8786E−01 | −8.6504E−02 | −2.3377E−03 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1970E−01 | 6.7760E−02 | −7.5599E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3646E−02 | −2.9904E−02 | 5.4758E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.4060E−03 | 6.7354E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 1.9946E−05 | 7.4849E−05 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 6-2

| SURFACE NUMBER | 10 | 11 | 12 | 13 |
|---|---|---|---|---|
| Y CURVATURE RADIUS R | −8.359 | −8.382 | −46.453 | 4.523 |
| NORMALIZED RADIUS | 0.0000E+00 | 0.0000E+00 | 0.0000E+00 | 0.0000E+00 |
| CONIC CONSTANT K | −3.6228E+00 | 1.0000E+01 | −1.0000E+01 | 2.9404E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −9.3347E−02 | −2.0460E−02 | 1.5450E−02 |
| FOURTH-ORDER ASPHERIC COEFFICIENT | −1.6022E−02 | 4.0748E−01 | 3.1898E−02 | −2.2145E−02 |
| FIFTH-ORDER ASPHERIC COEFFICIENT | 0.0000E+00 | −9.5396E−01 | 4.0302E−02 | 1.7866E−02 |
| SIXTH-ORDER ASPHERIC COEFFICIENT | 2.5894E−03 | 1.3921E+00 | −4.7547E−01 | −7.1555E−02 |
| SEVENTH-ORDER ASPHERIC COEFFICIENT | 0.0000E+00 | −2.2948E+00 | 6.1983E−01 | 3.2075E−02 |
| EIGHTH-ORDER ASPHERIC COEFFICIENT | −1.4248E−02 | 4.0685E+00 | −2.0424E−01 | −4.4668E−03 |
| NINTH-ORDER ASPHERIC COEFFICIENT | 0.0000E+00 | −4.4395E+00 | −6.4525E−02 | 1.6888E−02 |
| TENTH-ORDER ASPHERIC COEFFICIENT | −8.5650E−04 | 1.7057E+00 | −5.1063E−02 | −1.2246E−02 |
| 11TH-ORDER ASPHERIC COEFFICIENT | 0.0000E+00 | 9.1614E−01 | 8.5974E−02 | −2.8034E−03 |
| 12TH-ORDER ASPHERIC COEFFICIENT | 3.0471E−03 | −7.2315E−01 | 1.2890E−02 | 3.3550E−03 |
| 13TH-ORDER ASPHERIC COEFFICIENT | 0.0000E+00 | −2.0896E−01 | −3.0000E−02 | −7.5461E−05 |
| 14TH-ORDER ASPHERIC COEFFICIENT | 0.0000E+00 | 1.3023E−01 | −7.0199E−03 | −2.2883E−04 |
| 15TH-ORDER ASPHERIC COEFFICIENT | 0.0000E+00 | 1.0823E−01 | 1.2877E−02 | 1.8909E−05 |
| 16TH-ORDER ASPHERIC COEFFICIENT | 0.0000E+00 | −5.1408E−02 | −3.0962E−03 | 5.1886E−07 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.552 | 2.236 | 1.654 |
| NORMALIZED RADIUS | 0.0000E+00 | 0.0000E+00 | 0.0000E+00 |
| CONIC CONSTANT K | 1.8975E+00 | −5.8156E−01 | −1.1882E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.1291E−02 | −3.8766E−02 | 1.4423E−02 |
| FOURTH-ORDER ASPHERIC COEFFICIENT | −6.5552E−02 | −2.1093E−01 | −2.3682E−01 |
| FIFTH-ORDER ASPHERIC COEFFICIENT | 1.3823E−01 | 8.5687E−02 | 1.2809E−01 |
| SIXTH-ORDER ASPHERIC COEFFICIENT | −1.1134E−01 | 9.7623E−03 | 4.1394E−04 |
| SEVENTH-ORDER ASPHERIC COEFFICIENT | 2.5454E−02 | −4.7464E−03 | −2.0586E−02 |
| EIGHTH-ORDER ASPHERIC COEFFICIENT | 4.7689E−03 | −2.8785E−03 | 4.7596E−03 |
| NINTH-ORDER ASPHERIC COEFFICIENT | −1.7822E−03 | 7.6861E−04 | 3.6346E−04 |
| TENTH-ORDER ASPHERIC COEFFICIENT | 1.5757E−04 | 2.8593E−04 | −5.1834E−06 |
| 11TH-ORDER ASPHERIC COEFFICIENT | −1.2884E−04 | −4.1892E−05 | −3.8407E−05 |
| 12TH-ORDER ASPHERIC COEFFICIENT | −1.0441E−04 | −3.3891E−05 | −2.1169E−05 |
| 13TH-ORDER ASPHERIC COEFFICIENT | 4.4953E−05 | 6.7200E−08 | 4.8324E−06 |
| 14TH-ORDER ASPHERIC COEFFICIENT | 1.5789E−05 | 1.8194E−06 | 1.0335E−06 |
| 15TH-ORDER ASPHERIC COEFFICIENT | −5.6678E−06 | 6.2258E−07 | −1.1708E−07 |
| 16TH-ORDER ASPHERIC COEFFICIENT | −3.2781E−08 | −1.7946E−07 | −2.5182E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 2 are illustrated in Table 7.

TABLE 7

| | |
|---|---|
| FOCAL LENGTH | 4.60 |
| F-NUM8ER | 1.6 |
| TOTAL LENGTH | 5.808 |
| ω | 40.1 |

A focal length of each lens in the numerical value example 2 is illustrated in Table 8.

TABLE 8

| | FOCAL LENGTH |
|---|---|
| L1 | 5.00 |
| L2 | 17.77 |
| L3 | −11.23 |
| L4 | 18.37 |
| L5 | −15.76 |
| L6 | 105.71 |
| L7 | −24.35 |

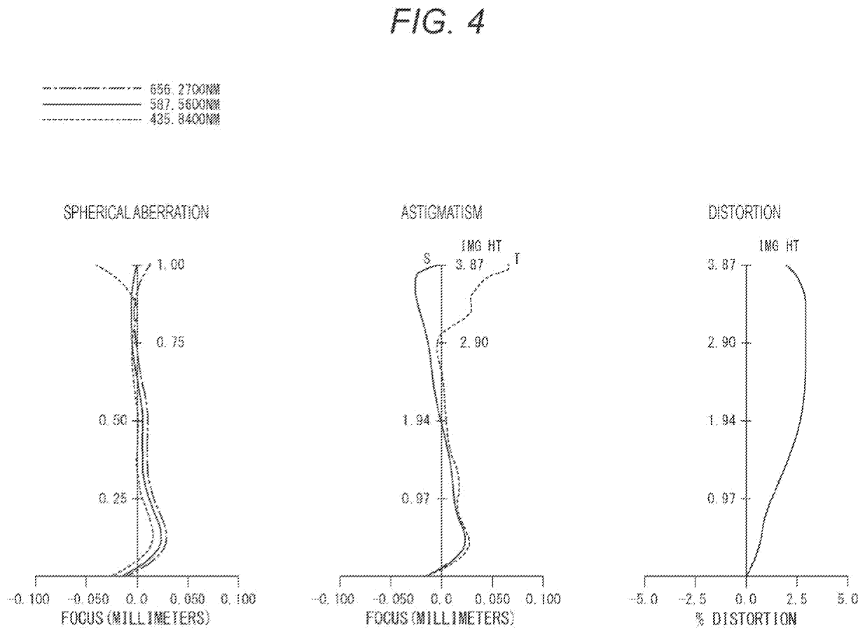

FIG. 4 is an aberration diagram of the numerical value example 2. In FIG. 4, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 2, and this has an excellent image forming performance.

### Third Embodiment

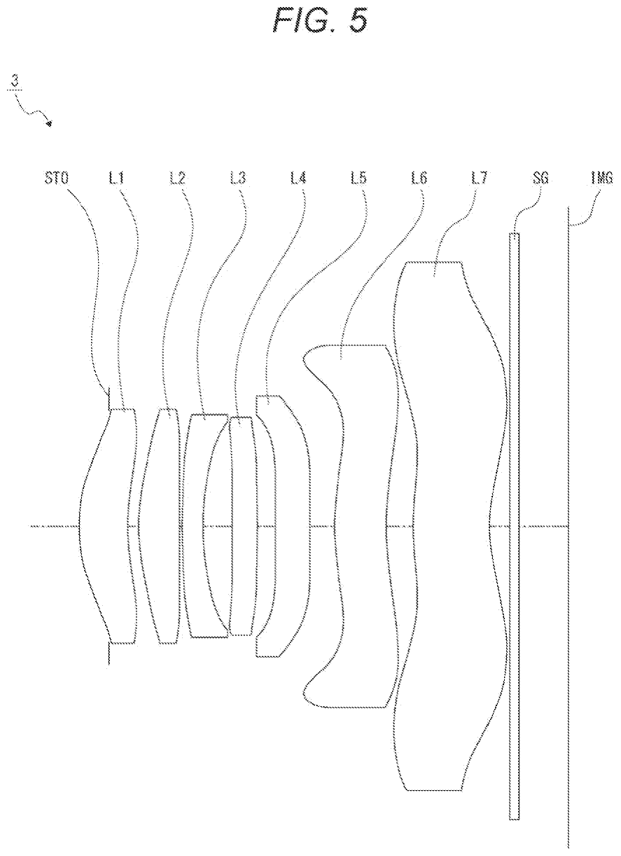

FIG. 5 illustrates a lens configuration of an imaging lens 3 in a third embodiment of the present technology.

The imaging lens 3 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a positive refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 9 illustrates lens data of a numerical value example 3 in which specific numerical values are applied to the imaging lens 3.

TABLE 9

| SURFACE | | | | REFRACTIVE | ABBE |
|---|---|---|---|---|---|
| NUMBER | LENS | R | T | INDEX | NUMBER |
| 1 | | INFINITY | 0.350 | | |
| 2 | DIAPHRAGM | INFINITY | −0.350 | | |
| 3 | L1R1 | 2.089 | 0.572 | 1.544 | 56.1 |
| 4 | L1R2 | 2.856 | 0.132 | | |
| 5 | L2R1 | 2.480 | 0.485 | 1.544 | 56.1 |
| 6 | L2R2 | 11.637 | 0.034 | | |
| 7 | L3R1 | 8.500 | 0.250 | 1.671 | 19.2 |
| 8 | L3R2 | 3.848 | 0.350 | | |
| 9 | L4R1 | −687.666 | 0.300 | 1.544 | 56.1 |
| 10 | L4R2 | −45.679 | 0.214 | | |
| 11 | L5R1 | 21.805 | 0.410 | 1.644 | 22.5 |
| 12 | L5R2 | 22.111 | 0.295 | | |
| 13 | L6R1 | 3.750 | 0.617 | 1.616 | 25.8 |
| 14 | L6R2 | 4.037 | 0.322 | | |
| 15 | L7R1 | 3.112 | 0.906 | 1.535 | 55.7 |
| 16 | L7R2 | 1.915 | 0.245 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 3 are illustrated in Tables 10-1 and 10-2 together with a conic constant K.

TABLE 10-1

| SURFACE NUMBER | 3 | 4 | 5 | 6 |
|---|---|---|---|---|
| Y CURVATURE RADIUS R | 2.089 | 2.856 | 2.480 | 11.637 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.4312E−02 | −7.3784E−02 | −6.5519E−02 | −1.1917E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −8.0325E−03 | 1.0998E−03 | 8.7305E−04 | 1.9633E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.7914E−03 | −1.7086E−02 | −2.1595E−02 | −2.0339E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −7.0068E−03 | 1.6793E−02 | 2.8390E−02 | 1.1882E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.5717E−03 | −5.5033E−03 | −7.8474E−03 | −3.5918E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 5.9004E−04 | 0.0000E+00 | 4.1489E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 8.500 | 3.848 | −687.666 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −9.3456E−02 | −1.6704E−03 | −1.1048E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0517E−01 | 5.9417E−02 | 3.0762E−03 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1453E−01 | −9.1281E−02 | −1.9066E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1964E−01 | 7.3803E−02 | 5.8004E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3588E−02 | −3.1160E−02 | 2.9616E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.9604E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 10-2

| SURFACE NUMBER | 10 | 11 | 12 | 13 |
|---|---|---|---|---|
| Y CURVATURE RADIUS R | −45.679 | 21.805 | 22.111 | 3.750 |
| NORMALIZED RADIUS | 0.0000E+00 | 0.0000E+00 | 0.0000E+00 | 0.0000E+00 |
| CONIC CONSTANT K | 0.0000E+00 | −9.0540E−02 | 1.3579E−01 | 6.7062E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.1369E−01 | 7.6163E−03 | −2.3416E−03 |
| FOURTH-ORDER ASPHERIC COEFFICIENT | −2.5265E−02 | 4.4508E−01 | −9.5719E−02 | 1.8046E−02 |
| FIFTH-ORDER ASPHERIC COEFFICIENT | 0.0000E+00 | −1.1113E+00 | 1.9402E−01 | −4.7001E−02 |
| SIXTH-ORDER ASPHERIC COEFFICIENT | 3.0798E−02 | 1.5422E+00 | −5.5115E−01 | −2.6387E−02 |
| SEVENTH-ORDER ASPHERIC COEFFICIENT | 0.0000E+00 | −2.2774E+00 | 6.1162E−01 | 2.6053E−02 |
| EIGHTH-ORDER ASPHERIC COEFFICIENT | −4.1674E−02 | 4.0184E+00 | −1.9119E−01 | −1.2775E−02 |
| NINTH-ORDER ASPHERIC COEFFICIENT | 0.0000E+00 | −4.4706E+00 | −5.8602E−02 | 1.6897E−02 |
| TENTH-ORDER ASPHERIC COEFFICIENT | 1.2491E−02 | 1.7091E+00 | −5.2442E−02 | −1.1010E−02 |
| 11TH-ORDER ASPHERIC COEFFICIENT | 0.0000E+00 | 9.3488E−01 | 8.3617E−02 | −2.0817E−03 |
| 12TH-ORDER ASPHERIC COEFFICIENT | 1.4576E−03 | −7.0946E−01 | 1.2235E−02 | 3.3662E−03 |
| 13TH-ORDER ASPHERIC COEFFICIENT | 0.0000E+00 | −2.0916E−01 | −2.9708E−02 | −1.7208E−04 |
| 14TH-ORDER ASPHERIC COEFFICIENT | 0.0000E+00 | 1.2191E−01 | −6.7175E−03 | −2.9779E−04 |
| 15TH-ORDER ASPHERIC COEFFICIENT | 0.0000E+00 | 1.0176E−01 | 1.3021E−02 | 4.2877E−07 |
| 16TH-ORDER ASPHERIC COEFFICIENT | 0.0000E+00 | −4.6542E−02 | −3.2502E−03 | 1.9089E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.037 | 3.112 | 1.915 |
| NORMALIZED RADIUS | 0.0000E+00 | 0.0000E+00 | 0.0000E+00 |
| CONIC CONSTANT K | 1.3209E+00 | −1.0313E−01 | −7.0537E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −2.2084E−02 | −7.2667E−03 | 1.4799E−02 |
| FOURTH-ORDER ASPHERIC COEFFICIENT | −4.6937E−02 | −2.1755E−01 | −2.2160E−01 |
| FIFTH-ORDER ASPHERIC COEFFICIENT | 1.2372E−01 | 9.9567E−02 | 1.1048E−01 |
| SIXTH-ORDER ASPHERIC COEFFICIENT | −1.1833E−01 | 5.3373E−03 | 5.3633E−03 |
| SEVENTH-ORDER ASPHERIC COEFFICIENT | 2.9077E−02 | −5.5493E−03 | −2.1382E−02 |
| EIGHTH-ORDER ASPHERIC COEFFICIENT | 6.3370E−03 | −2.8637E−03 | 4.6644E−03 |
| NINTH-ORDER ASPHERIC COEFFICIENT | −2.1202E−03 | 8.2543E−04 | 3.8520E−04 |
| TENTH-ORDER ASPHERIC COEFFICIENT | −2.6832E−05 | 3.0982E−04 | 4.4043E−06 |
| 11TH-ORDER ASPHERIC COEFFICIENT | −1.5260E−04 | −3.7984E−05 | −3.6989E−05 |
| 12TH-ORDER ASPHERIC COEFFICIENT | −8.9466E−05 | −3.4173E−05 | −2.1223E−05 |
| 13TH-ORDER ASPHERIC COEFFICIENT | 4.8459E−05 | −3.9664E−07 | 4.7701E−06 |
| 14TH-ORDER ASPHERIC COEFFICIENT | 1.5905E−05 | 1.6513E−06 | 1.0138E−06 |
| 15TH-ORDER ASPHERIC COEFFICIENT | −6.1149E−06 | 5.8086E−07 | −1.1835E−07 |
| 16TH-ORDER ASPHERIC COEFFICIENT | 2.6706E−08 | −1.5808E−07 | −2.7606E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 3 are illustrated in Table 11.

TABLE 11

| | |
|---|---|
| FOCAL LENGTH | 4.60 |
| F-NUMBER | 1.6 |
| TOTAL LENGTH | 5.832 |
| ω | 40.0 |

A focal length of each lens in the numerical value example 3 is illustrated in Table 12.

TABLE 12

| | FOCAL LENGTH |
|---|---|
| L1 | 11.29 |
| L2 | 5.67 |
| L3 | −10.59 |
| L4 | 89.68 |
| L5 | 1584.99 |
| L6 | 46.60 |
| L7 | −12.61 |

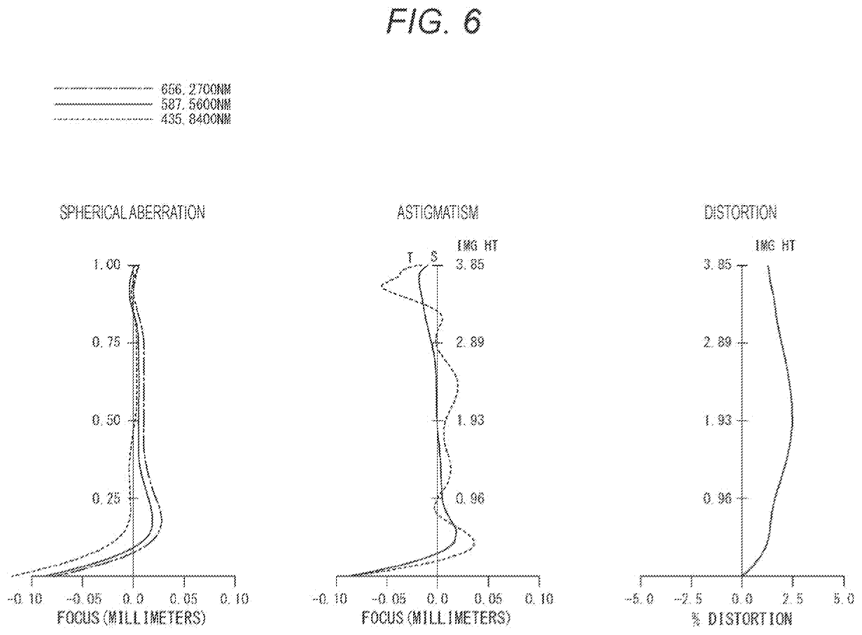

FIG. 6 is an aberration diagram of the numerical value example 3. In FIG. 6, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 3, and this has an excellent image forming performance.

### Fourth Embodiment

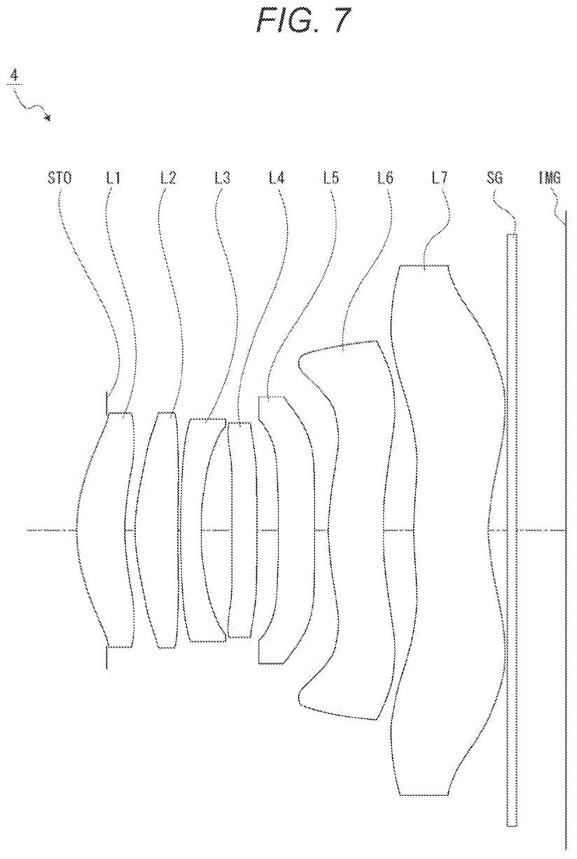

FIG. 7 illustrates a lens configuration of an imaging lens 4 in a fourth embodiment of the present technology.

The imaging lens 4 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 13 illustrates lens data of a numerical value example 4 in which specific numerical values are applied to the imaging lens 4.

TABLE 13

| SURFACE | | | | REFRACTIVE | ABBE |
|---|---|---|---|---|---|
| NUMBER | LENS | R | T | INDEX | NUMBER |
| 1 | | INFINITY | 0.350 | | |
| 2 | DIAPHRAGM | INFINITY | −0.350 | | |
| 3 | L1R1 | 2.104 | 0.570 | 1.544 | 56.1 |
| 4 | L1R2 | 2.735 | 0.121 | | |
| 5 | L2R1 | 2.315 | 0.510 | 1.544 | 56.1 |
| 6 | L2R2 | 11.489 | 0.030 | | |
| 7 | L3R1 | 8.565 | 0.250 | 1.671 | 19.2 |
| 8 | L3R2 | 4.027 | 0.368 | | |
| 9 | L4R1 | −1005.522 | 0.300 | 1.544 | 56.1 |
| 10 | L4R2 | −107.484 | 0.255 | | |
| 11 | L5R1 | −542.453 | 0.428 | 1.644 | 22.5 |
| 12 | L5R2 | 11.374 | 0.166 | | |
| 13 | L6R1 | 2.885 | 0.655 | 1.616 | 25.8 |
| 14 | L6R2 | 4.070 | 0.359 | | |
| 15 | L7R1 | 3.052 | 0.886 | 1.535 | 55.7 |
| 16 | L7R2 | 1.897 | 0.234 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 4 are illustrated in Tables 14-1 and 14-2 together with a conic constant K.

TABLE 14-1

| SURFACE NUMBER | 3 | 4 | 5 | 6 |
|---|---|---|---|---|
| Y CURVATURE RADIUS R | 2.104 | 2.735 | 2.315 | 11.489 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.5346E−02 | −8.2543E−02 | −7.0709E−02 | −1.2411E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −7.8159E−03 | 5.5796E−03 | 2.0396E−03 | 1.9782E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.7611E−03 | −1.8123E−02 | −2.0858E−02 | −2.0246E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.9946E−03 | 1.6782E−02 | 2.6916E−02 | 1.1847E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.5641E−03 | −5.5936E−03 | −7.2676E−03 | −3.5722E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 6.2833E−04 | 0.0000E+00 | 4.1060E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 8.565 | 4.027 | −1005.522 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −9.2329E−02 | 4.4136E−03 | −2.6781E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0876E−01 | 6.2344E−02 | 1.1017E−02 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1640E−01 | −9.3274E−02 | −2.1997E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.2091E−01 | 7.3451E−02 | 7.8864E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.4561E−02 | −3.1006E−02 | 2.2886E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 4.1663E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 14-2

| SURFACE NUMBER | 10 | 11 | 12 | 13 |
|---|---|---|---|---|
| Y CURVATURE RADIUS R | −107.484 | −542.453 | 11.374 | 2.885 |
| NORMALIZED RADIUS | 0.0000E+00 | 0.0000E+00 | 0.0000E+00 | 0.0000E+00 |
| CONIC CONSTANT K | 0.0000E+00 | −2.4328E−01 | −2.6895E−01 | −6.5179E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.1882E−01 | −2.0120E−03 | −9.1949E−03 |
| FOURTH-ORDER ASPHERIC COEFFICIENT | −3.3600E−02 | 4.5343E−01 | −1.1013E−01 | −1.0656E−02 |
| FIFTH-ORDER ASPHERIC COEFFICIENT | 0.0000E+00 | −1.0932E+00 | 1.9783E−01 | −3.7689E−02 |
| SIXTH-ORDER ASPHERIC COEFFICIENT | 2.6942E−02 | 1.5263E+00 | −5.4514E−01 | −1.8939E−02 |
| SEVENTH-ORDER ASPHERIC COEFFICIENT | 0.0000E+00 | −2.2857E+00 | 6.1229E−01 | 2.5687E−02 |
| EIGHTH-ORDER ASPHERIC COEFFICIENT | −3.4538E−02 | 4.0285E+00 | −1.9100E−01 | −1.3307E−02 |
| NINTH-ORDER ASPHERIC COEFFICIENT | 0.0000E+00 | −4.4663E+00 | −5.9203E−02 | 1.6015E−02 |
| TENTH-ORDER ASPHERIC COEFFICIENT | 9.4344E−03 | 1.7071E+00 | −5.3298E−02 | −1.1168E−02 |
| 11TH-ORDER ASPHERIC COEFFICIENT | 0.0000E+00 | 9.2923E−01 | 8.3784E−02 | −2.0097E−03 |
| 12TH-ORDER ASPHERIC COEFFICIENT | 1.9824E−03 | −7.0692E−01 | 1.2309E−02 | 3.4175E−03 |
| 13TH-ORDER ASPHERIC COEFFICIENT | 0.0000E+00 | −2.0847E−01 | −2.9676E−02 | −1.4828E−04 |
| 14TH-ORDER ASPHERIC COEFFICIENT | 0.0000E+00 | 1.2186E−01 | −6.7023E−03 | −2.9090E−04 |
| 15TH-ORDER ASPHERIC COEFFICIENT | 0.0000E+00 | 1.0154E−01 | 1.3029E−02 | −1.0549E−06 |
| 16TH-ORDER ASPHERIC COEFFICIENT | 0.0000E+00 | −4.6497E−02 | −3.2552E−03 | 1.6398E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.070 | 3.052 | 1.897 |
| NORMALIZED RADIUS | 0.0000E+00 | 0.0000E+00 | 0.0000E+00 |
| CONIC CONSTANT K | 1.3374E+00 | −1.5923E−01 | −7.1331E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.2730E−02 | −9.6147E−03 | 1.3950E−02 |
| FOURTH-ORDER ASPHERIC COEFFICIENT | −3.4100E−02 | −2.2062E−01 | −2.2578E−01 |
| FIFTH-ORDER ASPHERIC COEFFICIENT | 1.1763E−01 | 1.0023E−01 | 1.1320E−01 |
| SIXTH-ORDER ASPHERIC COEFFICIENT | −1.1806E−01 | 5.5909E−03 | 5.0418E−03 |
| SEVENTH-ORDER ASPHERIC COEFFICIENT | 2.9817E−02 | −5.5315E−03 | −2.1559E−02 |
| EIGHTH-ORDER ASPHERIC COEFFICIENT | 6.3446E−03 | −2.8749E−03 | 4.6509E−03 |
| NINTH-ORDER ASPHERIC COEFFICIENT | −2.1929E−03 | 8.2238E−04 | 3.9284E−04 |
| TENTH-ORDER ASPHERIC COEFFICIENT | −4.6721E−05 | 3.0954E−04 | 6.6724E−06 |
| 11TH-ORDER ASPHERIC COEFFICIENT | −1.5323E−04 | −3.8138E−05 | −3.6820E−05 |
| 12TH-ORDER ASPHERIC COEFFICIENT | −8.7272E−05 | −3.4175E−05 | −2.1190E−05 |
| 13TH-ORDER ASPHERIC COEFFICIENT | 4.9488E−05 | −3.8635E−07 | 4.7619E−06 |
| 14TH-ORDER ASPHERIC COEFFICIENT | 1.6040E−05 | 1.6549E−06 | 1.0109E−06 |
| 15TH-ORDER ASPHERIC COEFFICIENT | −6.1415E−06 | 5.8214E−07 | −1.1949E−07 |
| 16TH-ORDER ASPHERIC COEFFICIENT | −1.3239E−08 | −1.5807E−07 | −2.7672E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 4 are illustrated in Table 15.

TABLE 15

| | |
|---|---|
| FOCAL LENGTH | 4.60 |
| F-NUMBER | 1.6 |
| TOTAL LENGTH | 5.832 |
| ω | 40.0 |

A focal length of each lens in the numerical value example 4 is illustrated in Table 16.

TABLE 16

| | FOCAL LENGTH |
|---|---|
| L1 | 12.68 |
| L2 | 5.21 |
| L3 | −11.45 |
| L4 | 220.59 |
| L5 | −17.11 |
| L6 | 13.18 |
| L7 | −38.05 |

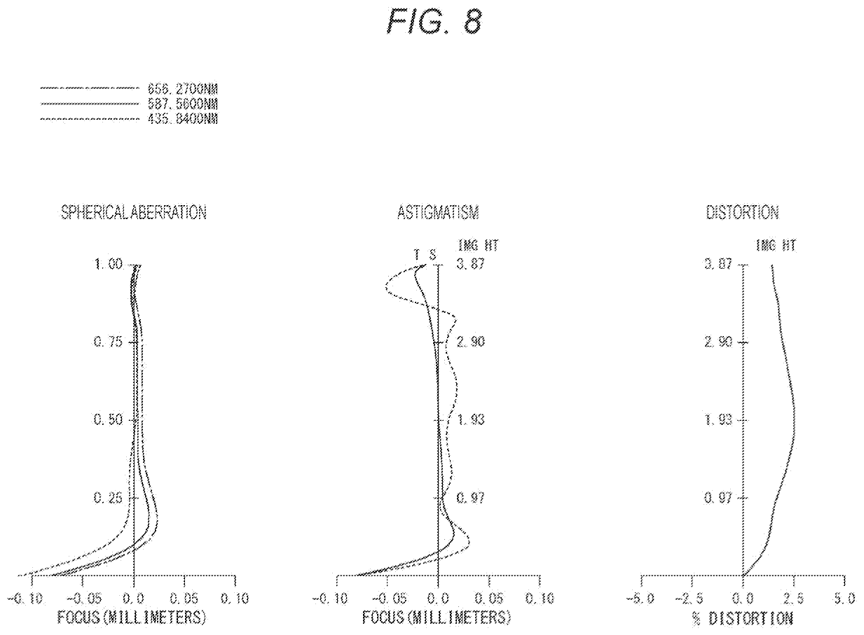

FIG. 8 is an aberration diagram of the numerical value example 4. In FIG. 8, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 4, and this has an excellent image forming performance.

### Fifth Embodiment

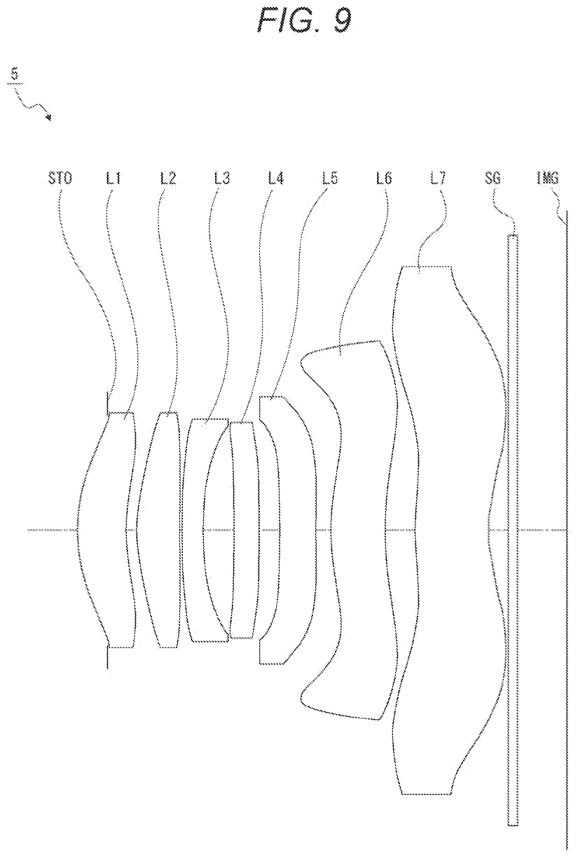

FIG. 9 illustrates a lens configuration of an imaging lens 5 in a fifth embodiment of the present technology.

The imaging lens 5 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 17 illustrates lens data of a numerical value example 5 in which specific numerical values are applied to the imaging lens 5.

TABLE 17

| SURFACE | | | | REFRACTIVE | ABBE |
|---|---|---|---|---|---|
| NUMBER | LENS | R | T | INDEX | NUMBER |
| 1 | | INFINITY | 0.350 | | |
| 2 | DIAPHRAGM | INFINITY | −0.350 | | |
| 3 | L1R1 | 2.111 | 0.577 | 1.544 | 56.1 |
| 4 | L1R2 | 2.713 | 0.124 | | |
| 5 | L2R1 | 2.292 | 0.512 | 1.544 | 56.1 |
| 6 | L2R2 | 11.988 | 0.030 | | |
| 7 | L3R1 | 8.642 | 0.250 | 1.671 | 19.2 |
| 8 | L3R2 | 3.972 | 0.370 | | |
| 9 | L4R1 | −1005.522 | 0.300 | 1.544 | 56.1 |
| 10 | L4R2 | −107.484 | 0.247 | | |
| 11 | L5R1 | 82.477 | 0.431 | 1.644 | 22.5 |
| 12 | L5R2 | 10.431 | 0.177 | | |
| 13 | L6R1 | 2.912 | 0.650 | 1.616 | 25.8 |
| 14 | L6R2 | 4.066 | 0.355 | | |
| 15 | L7R1 | 3.067 | 0.877 | 1.535 | 55.7 |
| 16 | L7R2 | 1.899 | 0.234 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 5 are illustrated in Tables 18-1 and 18-2 together with a conic constant K.

TABLE 18-1

| SURFACE NUMBER | 3 | 4 | 5 | 6 |
|---|---|---|---|---|
| Y CURVATURE RADIUS R | 2.111 | 2.713 | 2.292 | 11.988 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.5420E−02 | −8.0267E−02 | −6.8292E−02 | −1.2033E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −7.7736E−03 | 2.2735E−03 | 7.4777E−04 | 1.9595E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.3551E−03 | −1.6914E−02 | −2.2950E−02 | −2.0331E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.6157E−03 | 1.6695E−02 | 2.8500E−02 | 1.1941E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.4882E−03 | −5.5988E−03 | −7.5573E−03 | −3.5741E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 6.2339E−04 | 0.0000E+00 | 4.0355E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 8.642 | 3.972 | −1005.522 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −8.8619E−02 | 5.2787E−03 | −2.6857E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0678E−01 | 6.4587E−02 | 1.1596E−02 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1448E−01 | −9.4912E−02 | −1.9602E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1894E−01 | 7.3825E−02 | 6.7001E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3582E−02 | −3.1006E−02 | 2.2886E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.9848E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 18-2

| SURFACE NUMBER | 10 | 11 | 12 | 13 |
|---|---|---|---|---|
| Y CURVATURE RADIUS R | −107.484 | 82.477 | 10.431 | 2.912 |
| NORMALIZED RADIUS | 0.0000E+00 | 0.0000E+00 | 0.0000E+00 | 0.0000E+00 |
| CONIC CONSTANT K | 0.0000E+00 | −2.4828E−01 | 2.3692E−01 | −4.7638E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.2531E+01 | −1.1979E−02 | −1.4289E−02 |
| FOURTH-ORDER ASPHERIC COEFFICIENT | −3.6486E−02 | 4.6304E−01 | −1.0235E−01 | −3.8575E−03 |
| FIFTH-ORDER ASPHERIC COEFFICIENT | 0.0000E+00 | −1.1155E+00 | 2.0169E−01 | −3.8279E−02 |
| SIXTH-ORDER ASPHERIC COEFFICIENT | 2.7404E−02 | 1.5415E+00 | −5.5144E−01 | −2.0768E−02 |
| SEVENTH-ORDER ASPHERIC COEFFICIENT | 0.0000E+00 | −2.2781E+00 | 6.1217E−01 | 2.5592E−02 |
| EIGHTH-ORDER ASPHERIC COEFFICIENT | −3.1023E−02 | 4.0180E+00 | −1.9071E−01 | −1.3669E−02 |
| NINTH-ORDER ASPHERIC COEFFICIENT | 0.0000E+00 | −4.4701E+00 | −5.8600E−02 | 1.6607E−02 |
| TENTH-ORDER ASPHERIC COEFFICIENT | 7.2863E−03 | 1.7099E+00 | −5.2520E−02 | −1.1091E−02 |
| 11TH-ORDER ASPHERIC COEFFICIENT | 0.0000E+00 | 9.3512E−01 | 8.3524E−02 | −2.0494E−03 |
| 12TH-ORDER ASPHERIC COEFFICIENT | 2.2280E−03 | −7.0966E−01 | 1.2198E−02 | 3.3984E−03 |
| 13TH-ORDER ASPHERIC COEFFICIENT | 0.0000E+00 | −2.0944E−01 | −2.9745E−02 | −1.6099E−04 |
| 14TH-ORDER ASPHERIC COEFFICIENT | 0.0000E+00 | 1.2175E−01 | −6.7402E−03 | −2.9502E−04 |
| 15TH-ORDER ASPHERIC COEFFICIENT | 0.0000E+00 | 1.0177E−01 | 1.3024E−02 | −6.9340E−07 |
| 16TH-ORDER ASPHERIC COEFFICIENT | 0.0000E+00 | −4.6472E−02 | −3.2317E−03 | 1.7922E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.066 | 3.067 | 1.899 |
| NORMALIZED RADIUS | 0.0000E+00 | 0.0000E+00 | 0.0000E+00 |
| CONIC CONSTANT K | 1.3228E+00 | −1.4326E−01 | −7.0886E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.1258E−02 | −8.1181E−03 | 1.4773E−02 |
| FOURTH-ORDER ASPHERIC COEFFICIENT | −3.5353E−02 | −2.2142E−01 | −2.2672E−01 |
| FIFTH-ORDER ASPHERIC COEFFICIENT | 1.1864E−01 | 1.0025E−01 | 1.1367E−01 |
| SIXTH-ORDER ASPHERIC COEFFICIENT | −1.1821E−01 | 5.6316E−03 | 4.9364E−03 |
| SEVENTH-ORDER ASPHERIC COEFFICIENT | 2.9632E−02 | −5.5262E−03 | −2.1585E−02 |
| EIGHTH-ORDER ASPHERIC COEFFICIENT | 6.3564E−03 | −2.8766E−03 | 4.6484E−03 |
| NINTH-ORDER ASPHERIC COEFFICIENT | −2.1477E−03 | 8.2180E−04 | 3.9349E−04 |
| TENTH-ORDER ASPHERIC COEFFICIENT | −4.6593E−05 | 3.0932E−04 | 7.3771E−06 |
| 11TH-ORDER ASPHERIC COEFFICIENT | −1.5541E−04 | −3.8115E−05 | −3.6602E−05 |
| 12TH-ORDER ASPHERIC COEFFICIENT | −8.8503E−05 | −3.4150E−05 | −2.1140E−05 |
| 13TH-ORDER ASPHERIC COEFFICIENT | 4.9238E−05 | −3.7593E−07 | 4.7690E−06 |
| 14TH-ORDER ASPHERIC COEFFICIENT | 1.6029E−05 | 1.6578E−06 | 1.0089E−06 |
| 15TH-ORDER ASPHERIC COEFFICIENT | −6.1269E−06 | 5.8165E−07 | −1.2077E−07 |
| 16TH-ORDER ASPHERIC COEFFICIENT | 8.7918E−09 | −1.5863E−07 | −2.8208E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 5 are illustrated in Table 19.

TABLE 19

| | |
|---|---|
| FOCAL LENGTH | 4.60 |
| F-NUMBER | 1.6 |
| TOTAL LENGTH | 5.832 |
| ω | 40.0 |

A focal length of each lens in the numerical value example 5 is illustrated in Table 20.

TABLE 20

| | FOCAL LENGTH |
|---|---|
| L1 | 13.03 |
| L2 | 5.10 |
| L3 | −11.07 |
| L4 | 220.59 |
| L5 | −18.39 |
| L6 | 13.61 |
| L7 | −30.98 |

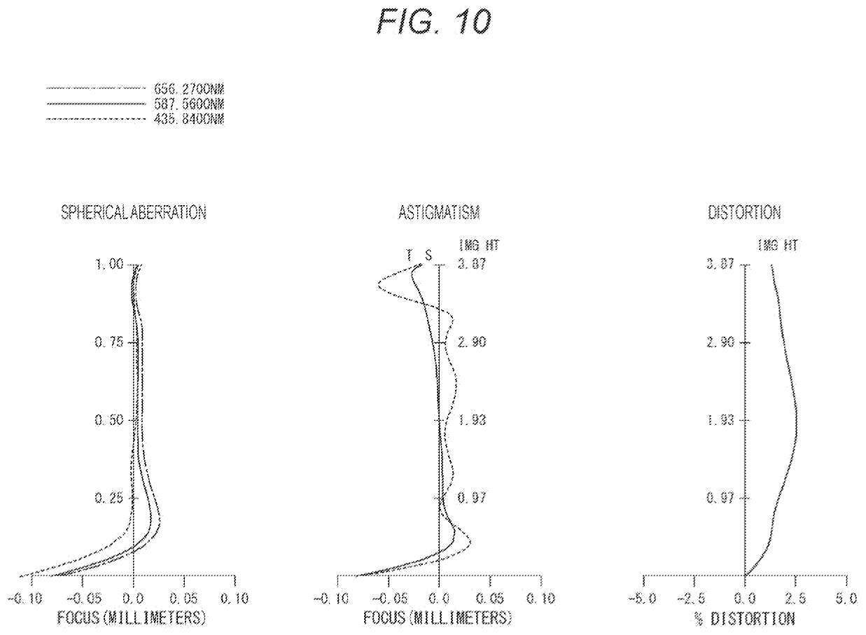

FIG. 10 is an aberration diagram of the numerical value example 5. In FIG. 10, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 5, and this has an excellent image forming performance.

### Sixth Embodiment

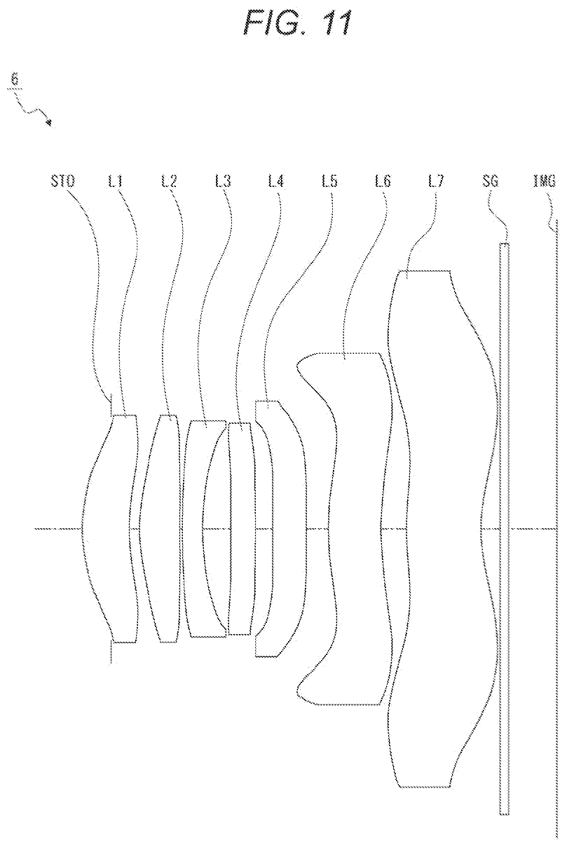

FIG. 11 illustrates a lens configuration of an imaging lens 6 in a sixth embodiment of the present technology.

The imaging lens 6 includes a first lens L1 having a positive refractive power with a convex surface facing an object side, a second lens L2 having a positive refractive power, a third lens L3 having a negative refractive power, a fourth lens L4 having a negative refractive power with a concave surface facing the object side, a fifth lens L5 having a positive refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 21 illustrates lens data of a numerical value example 6 in which specific numerical values are applied to the imaging lens 6.

TABLE 21

| SURFACE | | | | REFRACTIVE | ABBE |
|---|---|---|---|---|---|
| NUMBER | LENS | R | T | INDEX | NUMBER |
| 1 | | INFINITY | 0.350 | | |
| 2 | DIAPHRAGM | INFINITY | −0.350 | | |
| 3 | L1R1 | 2.095 | 0.575 | 1.544 | 56.1 |
| 4 | L1R2 | 2.865 | 0.126 | | |
| 5 | L2R1 | 2.460 | 0.492 | 1.544 | 56.1 |
| 6 | L2R2 | 12.495 | 0.032 | | |
| 7 | L3R1 | 9.056 | 0.250 | 1.671 | 19.2 |
| 8 | L3R2 | 3.991 | 0.350 | | |
| 9 | L4R1 | −810.788 | 0.300 | 1.544 | 56.1 |
| 10 | L4R2 | 489.167 | 0.216 | | |
| 11 | L5R1 | 16.293 | 0.411 | 1.644 | 22.5 |
| 12 | L5R2 | 16.463 | 0.274 | | |
| 13 | L6R1 | 3.736 | 0.642 | 1.616 | 25.8 |
| 14 | L6R2 | 4.080 | 0.314 | | |
| 15 | L7R1 | 3.087 | 0.912 | 1.535 | 55.7 |
| 16 | L7R2 | 1.936 | 0.238 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 6 are illustrated in Tables 22-1 and 22-2 together with a conic constant K.

TABLE 22-1

| SURFACE NUMBER | 3 | 4 | 5 | 6 |
|---|---|---|---|---|
| Y CURVATURE RADIUS R | 2.095 | 2.865 | 2.460 | 12.495 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.4206E−02 | −7.3920E−02 | −6.5049E−02 | −1.2024E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −7.7513E−03 | 1.3678E−03 | 7.3353E−04 | 1.9664E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.5132E−03 | −1.7220E−02 | −2.1859E−02 | −2.0326E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.8564E−03 | 1.6802E−02 | 2.8444E−02 | 1.1836E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.5281E−03 | −5.5009E−03 | −7.7990E−03 | −3.5889E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 5.8323E−04 | 0.0000E+00 | 4.1251E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 9.056 | 3.991 | −810.788 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −9.1634E−02 | 1.8306E−03 | −1.4292E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0523E−01 | 5.9761E−02 | 3.9361E−03 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1448E−01 | −9.1949E−02 | −1.8266E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1952E−01 | 7.3725E−02 | 6.5504E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3550E−02 | −3.1036E−02 | 2.3692E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.9608E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 22-2

| SURFACE NUMBER | 10 | 11 | 12 | 13 |
|---|---|---|---|---|
| Y CURVATURE RADIUS R | 489.167 | 16.293 | 16.463 | 3.736 |
| NORMALIZED RADIUS | 0.0000E+00 | 0.0000E+00 | 0.0000E+00 | 0.0000E+00 |
| CONIC CONSTANT K | 0.0000E+00 | −1.2183E−01 | 3.8220E−01 | 2.1164E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.1396E−01 | 6.1088E−03 | −4.9214E−03 |
| FOURTH-ORDER ASPHERIC COEFFICIENT | −2.8574E−02 | 4.4461E−01 | −9.8231E−02 | 1.7411E−02 |
| FIFTH-ORDER ASPHERIC COEFFICIENT | 0.0000E+00 | −1.1129E+00 | 1.9588E−01 | −4.7154E−02 |
| SIXTH-ORDER ASPHERIC COEFFICIENT | 2.8628E−02 | 1.5433E+00 | −5.5217E−01 | −2.6199E−02 |
| SEVENTH-ORDER ASPHERIC COEFFICIENT | 0.0000E+00 | −2.2770E+00 | 6.1156E−01 | 2.5958E−02 |
| EIGHTH-ORDER ASPHERIC COEFFICIENT | −3.7993E−02 | 4.0182E+00 | −1.9097E−01 | −1.2743E−02 |
| NINTH-ORDER ASPHERIC COEFFICIENT | 0.0000E+00 | −4.4707E+00 | −5.8408E−02 | 1.6974E−02 |
| TENTH-ORDER ASPHERIC COEFFICIENT | 1.2060E−02 | 1.7094E+00 | −5.2335E−02 | −1.1026E−02 |
| 11TH-ORDER ASPHERIC COEFFICIENT | 0.0000E+00 | 9.3500E−01 | 8.3633E−02 | −2.0786E−03 |
| 12TH-ORDER ASPHERIC COEFFICIENT | 1.0119E−03 | −7.0948E−01 | 1.2212E−02 | 3.3684E−03 |
| 13TH-ORDER ASPHERIC COEFFICIENT | 0.0000E+00 | −2.0922E−01 | −2.9750E−02 | −1.7223E−04 |
| 14TH-ORDER ASPHERIC COEFFICIENT | 0.0000E+00 | 1.2186E−01 | −6.7447E−03 | −2.9755E−04 |
| 15TH-ORDER ASPHERIC COEFFICIENT | 0.0000E+00 | 1.0176E−01 | 1.3019E−02 | 9.8127E−08 |
| 16TH-ORDER ASPHERIC COEFFICIENT | 0.0000E+00 | −4.6546E−02 | −3.2337E−03 | 1.9095E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.080 | 3.087 | 1.936 |
| NORMALIZED RADIUS | 0.0000E+00 | 0.0000E+00 | 0.0000E+00 |
| CONIC CONSTANT K | 1.3254E+00 | −1.2289E−01 | −6.9959E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −2.6501E−02 | −7.1557E−03 | 1.7896E−02 |
| FOURTH-ORDER ASPHERIC COEFFICIENT | −4.3452E−02 | −2.1730E−01 | −2.2253E−01 |
| FIFTH-ORDER ASPHERIC COEFFICIENT | 1.2166E−01 | 9.9816E−02 | 1.1045E−01 |
| SIXTH-ORDER ASPHERIC COEFFICIENT | −1.1770E−01 | 5.1796E−03 | 5.5010E−03 |
| SEVENTH-ORDER ASPHERIC COEFFICIENT | 2.9437E−02 | −5.5383E−03 | −2.1459E−02 |
| EIGHTH-ORDER ASPHERIC COEFFICIENT | 6.2318E−03 | −2.8657E−03 | 4.6635E−03 |
| NINTH-ORDER ASPHERIC COEFFICIENT | −2.1440E−03 | 8.2463E−04 | 3.8725E−04 |
| TENTH-ORDER ASPHERIC COEFFICIENT | −2.9746E−05 | 3.0991E−04 | 5.1260E−06 |
| 11TH-ORDER ASPHERIC COEFFICIENT | −1.5253E−04 | −3.7965E−05 | −3.6928E−05 |
| 12TH-ORDER ASPHERIC COEFFICIENT | −8.8367E−05 | −3.4144E−05 | −2.1224E−05 |
| 13TH-ORDER ASPHERIC COEFFICIENT | 4.8635E−05 | −3.8308E−07 | 4.7649E−06 |
| 14TH-ORDER ASPHERIC COEFFICIENT | 1.5918E−05 | 1.6541E−06 | 1.0123E−06 |
| 15TH-ORDER ASPHERIC COEFFICIENT | −6.1216E−06 | 5.8068E−07 | −1.1856E−07 |
| 16TH-ORDER ASPHERIC COEFFICIENT | 1.7475E−08 | −1.5868E−07 | −2.7533E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 6 are illustrated in Table 23.

TABLE 23

| | |
|---|---|
| FOCAL LENGTH | 4.60 |
| F-NUMBER | 1.6 |
| TOTAL LENGTH | 5.832 |
| ω | 40.0 |

A focal length of each lens in the numerical value example 6 is illustrated in Table 24.

TABLE 24

| | FOCAL LENGTH |
|---|---|
| L1 | 11.32 |
| L2 | 5.52 |
| L3 | −10.72 |
| L4 | −559.25 |
| L5 | 1240.80 |
| L6 | 41.67 |
| L7 | −13.39 |

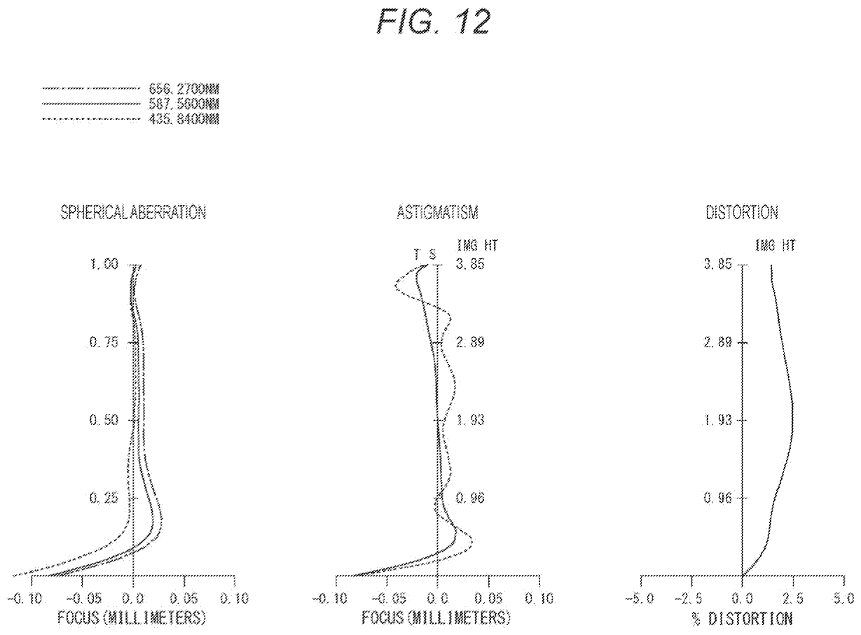

FIG. 12 is an aberration diagram of the numerical value example 6. In FIG. 12, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 6, and this has an excellent image forming performance.

### Seventh Embodiment

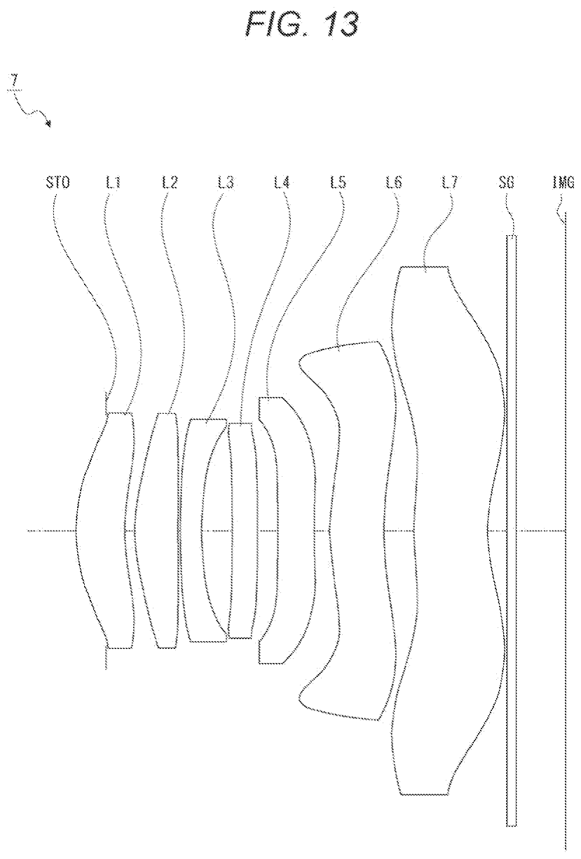

FIG. 13 illustrates a lens configuration of an imaging lens 7 in a seventh embodiment of the present technology.

The imaging lens 7 includes a first lens L1 having a positive refractive power with a convex surface facing an object side, a second lens L2 having a positive refractive power, a third lens L3 having a negative refractive power, a fourth lens L4 having a negative refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 25 illustrates lens data of a numerical value example 7 in which specific numerical values are applied to the imaging lens 7.

TABLE 25

| SURFACE | | | | REFRACTIVE | ABBE |
|---|---|---|---|---|---|
| NUMBER | LENS | R | T | INDEX | NUMBER |
| 1 | | INFINITY | 0.350 | | |
| 2 | DIAPHRAGM | INFINITY | −0.350 | | |
| 3 | L1R1 | 2.112 | 0.577 | 1.544 | 56.1 |
| 4 | L1R2 | 2.721 | 0.121 | | |
| 5 | L2R1 | 2.295 | 0.511 | 1.544 | 56.1 |
| 6 | L2R2 | 12.123 | 0.030 | | |
| 7 | L3R1 | 8.754 | 0.250 | 1.671 | 19.2 |
| 8 | L3R2 | 3.995 | 0.369 | | |
| 9 | L4R1 | −991.412 | 0.300 | 1.544 | 56.1 |
| 10 | L4R2 | 852.240 | 0.245 | | |
| 11 | L5R1 | 37.322 | 0.433 | 1.644 | 22.5 |
| 12 | L5R2 | 9.827 | 0.181 | | |
| 13 | L6R1 | 2.923 | 0.651 | 1.616 | 25.8 |
| 14 | L6R2 | 4.070 | 0.357 | | |
| 15 | L7R1 | 3.071 | 0.873 | 1.535 | 55.7 |
| 16 | L7R2 | 1.901 | 0.233 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 7 are illustrated in Tables 26-1 and 26-2 together with a conic constant K.

TABLE 26-1

| SURFACE NUMBER | 3 | 4 | 5 | 6 |
|---|---|---|---|---|
| Y CURVATURE RADIUS R | 2.112 | 2.721 | 2.295 | 12.123 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.5244E−02 | −8.0279E−02 | −6.8279E−02 | −1.2034E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −7.7278E−03 | 2.2840E−03 | 7.4774E−04 | 1.9597E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.3509E−03 | −1.6905E−02 | −2.2950E−02 | −2.0331E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.6267E−03 | 1.6697E−02 | 2.8497E−02 | 1.1941E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.4834E−03 | −5.6011E−03 | −7.5597E−03 | −3.5739E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 6.2080E−04 | 0.0000E+00 | 4.0364E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 8.754 | 3.995 | −991.412 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −8.8667E−02 | 5.6089E−03 | −2.7190E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0678E−01 | 6.4575E−02 | 1.1567E−02 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1445E−01 | −9.4950E−02 | −1.9536E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1895E−01 | 7.3833E−02 | 6.6959E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3581E−02 | −3.1008E−02 | 2.2888E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.9848E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 26-2

| SURFACE NUMBER | 10 | 11 | 12 | 13 |
|---|---|---|---|---|
| Y CURVATURE RADIUS R | 852.240 | 37.322 | 9.827 | 2.923 |
| NORMALIZED RADIUS | 0.0000E+00 | 0.0000E+00 | 0.0000E+00 | 0.0000E+00 |
| CONIC CONSTANT K | 0.0000E+00 | −2.4828E−01 | −4.7393E−01 | −4.7296E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.2556E−01 | −1.1611E−02 | −1.4293E−02 |
| FOURTH-ORDER ASPHERIC COEFFICIENT | −3.7402E−02 | 4.6277E−01 | −1.0293E−01 | −3.7564E−03 |
| FIFTH-ORDER ASPHERIC COEFFICIENT | 0.0000E+00 | −1.1157E+00 | 2.0174E−01 | −3.8347E−02 |
| SIXTH-ORDER ASPHERIC COEFFICIENT | 2.7569E−02 | 1.5416E+00 | −5.5140E−01 | −2.0829E−02 |
| SEVENTH-ORDER ASPHERIC COEFFICIENT | 0.0000E+00 | −2.2780E+00 | 6.1217E−01 | 2.5577E−02 |
| EIGHTH-ORDER ASPHERIC COEFFICIENT | −3.0958E−02 | 4.0181E+00 | −1.9072E−01 | −1.3671E−02 |
| NINTH-ORDER ASPHERIC COEFFICIENT | 0.0000E+00 | −4.4700E+00 | −5.8608E−02 | 1.6610E−02 |
| TENTH-ORDER ASPHERIC COEFFICIENT | 7.3001E−03 | 1.7099E+00 | −5.2523E−02 | −1.1089E−02 |
| 11TH-ORDER ASPHERIC COEFFICIENT | 0.0000E+00 | 9.3511E−01 | 8.3523E−02 | −2.0489E−03 |
| 12TH-ORDER ASPHERIC COEFFICIENT | 2.2100E−03 | −7.0967E−01 | 1.2198E−02 | 3.3987E−03 |
| 13TH-ORDER ASPHERIC COEFFICIENT | 0.0000E+00 | −2.0945E−01 | −2.9745E−02 | −1.6079E−04 |
| 14TH-ORDER ASPHERIC COEFFICIENT | 0.0000E+00 | 1.2174E−01 | −6.7408E−03 | −2.9498E−04 |
| 15TH-ORDER ASPHERIC COEFFICIENT | 0.0000E+00 | 1.0177E−01 | 1.3023E−02 | −6.7811E−07 |
| 16TH-ORDER ASPHERIC COEFFICIENT | 0.0000E+00 | −4.6469E−02 | −3.2325E−03 | 1.7911E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.070 | 3.071 | 1.901 |
| NORMALIZED RADIUS | 0.0000E+00 | 0.0000E+00 | 0.0000E+00 |
| CONIC CONSTANT K | 1.3221E+00 | −1.4344E−01 | −7.0896E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.1598E−02 | −7.8508E−03 | 1.4888E−02 |
| FOURTH-ORDER ASPHERIC COEFFICIENT | −3.5382E−02 | −2.2132E−01 | −2.2681E−01 |
| FIFTH-ORDER ASPHERIC COEFFICIENT | 1.1872E−01 | 1.0024E−01 | 1.1364E−01 |
| SIXTH-ORDER ASPHERIC COEFFICIENT | −1.1818E−01 | 5.6234E−03 | 4.9297E−03 |
| SEVENTH-ORDER ASPHERIC COEFFICIENT | 2.9634E−02 | −5.5283E−03 | −2.1585E−02 |
| EIGHTH-ORDER ASPHERIC COEFFICIENT | 6.3559E−03 | −2.8767E−03 | 4.6486E−03 |
| NINTH-ORDER ASPHERIC COEFFICIENT | −2.1478E−03 | 8.2180E−04 | 3.9358E−04 |
| TENTH-ORDER ASPHERIC COEFFICIENT | −4.6477E−05 | 3.0932E−04 | 7.3984E−06 |
| 11TH-ORDER ASPHERIC COEFFICIENT | −1.5534E−04 | −3.8112E−05 | −3.6597E−05 |
| 12TH-ORDER ASPHERIC COEFFICIENT | −8.8470E−05 | −3.4149E−05 | −2.1139E−05 |
| 13TH-ORDER ASPHERIC COEFFICIENT | 4.9243E−05 | −3.7567E−07 | 4.7692E−06 |
| 14TH-ORDER ASPHERIC COEFFICIENT | 1.6030E−05 | 1.6579E−06 | 1.0090E−06 |
| 15TH-ORDER ASPHERIC COEFFICIENT | −6.1274E−06 | 5.8170E−07 | −1.2076E−07 |
| 16TH-ORDER ASPHERIC COEFFICIENT | 8.0747E−09 | −1.5861E−07 | −2.8206E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 7 are illustrated in Table 27.

TABLE 27

| | |
|---|---|
| FOCAL LENGTH | 4.60 |
| F-NUMBER | 1.6 |
| TOTAL LENGTH | 5.832 |
| ω | 40.0 |

A focal length of each lens in the numerical value example 7 is illustrated in Table 28.

TABLE 28

| | FOCAL LENGTH |
|---|---|
| L1 | 12.95 |
| L2 | 5.09 |
| L3 | −11.06 |
| L4 | −840.07 |
| L5 | −20.62 |
| L6 | 13.75 |
| L7 | −12.58 |

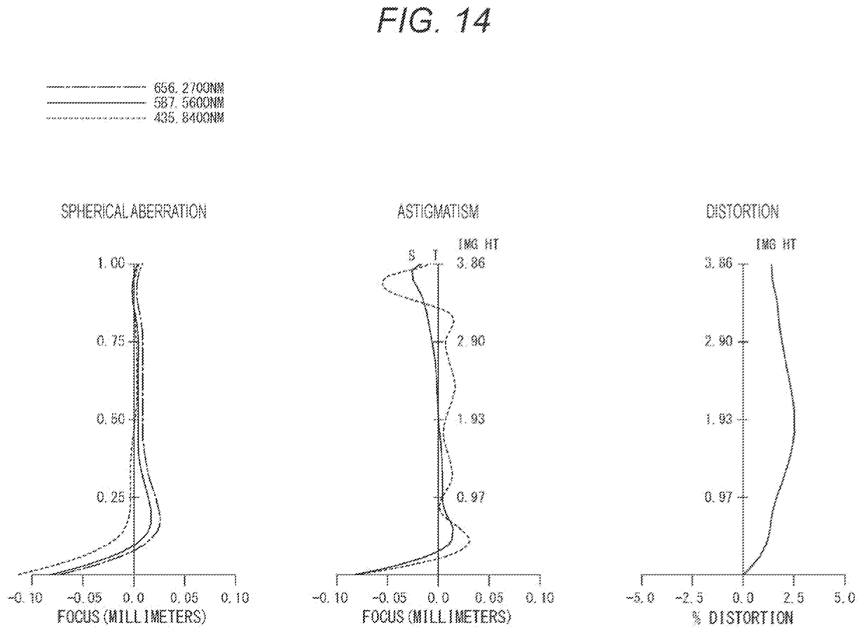

FIG. 14 is an aberration diagram of the numerical value example 7. In FIG. 14, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 7, and this has an excellent image forming performance.

### Eighth Embodiment

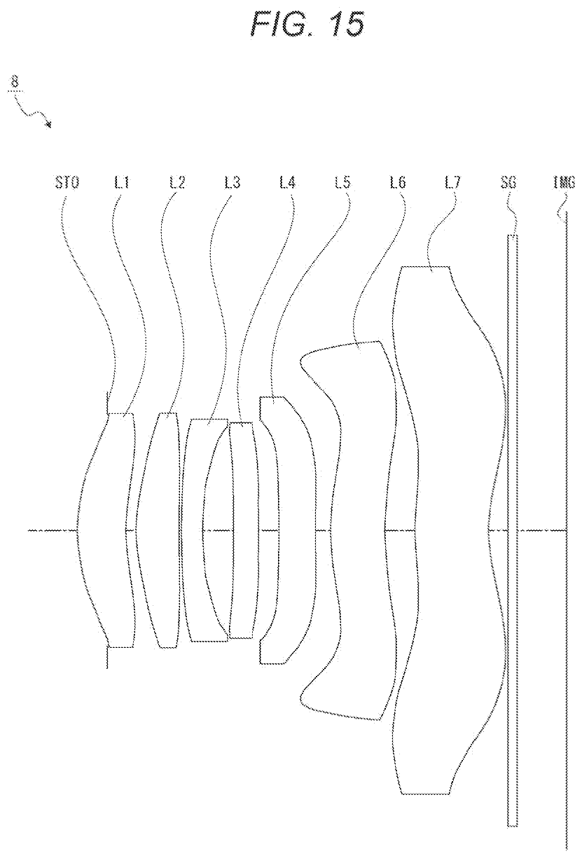

FIG. 15 illustrates a lens configuration of an imaging lens 8 in an eighth embodiment of the present technology.

The imaging lens 8 includes a first lens L1 having a positive refractive power with a convex surface facing an object side, a second lens L2 having a positive refractive power, a third lens L3 having a negative refractive power, a fourth lens L4 having a negative refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 29 illustrates lens data of a numerical value example 8 in which specific numerical values are applied to the imaging lens 8.

TABLE 29

| SURFACE | | | | REFRACTIVE | ABBE |
|---|---|---|---|---|---|
| NUMBER | LENS | R | T | INDEX | NUMBER |
| 1 | | INFINITY | 0.350 | | |
| 2 | DIAPHRAGM | INFINITY | −0.350 | | |
| 3 | L1R1 | 2.111 | 0.576 | 1.544 | 56.1 |
| 4 | L1R2 | 2.722 | 0.122 | | |
| 5 | L2R1 | 2.295 | 0.511 | 1.544 | 56.1 |
| 6 | L2R2 | 12.086 | 0.030 | | |
| 7 | L3R1 | 8.735 | 0.250 | 1.671 | 19.2 |
| 8 | L3R2 | 3.985 | 0.370 | | |
| 9 | L4R1 | −722.525 | 0.300 | 1.544 | 56.1 |
| 10 | L4R2 | −913.348 | 0.246 | | |
| 11 | L5R1 | 41.657 | 0.432 | 1.644 | 22.5 |
| 12 | L5R2 | 9.910 | 0.180 | | |
| 13 | L6R1 | 2.908 | 0.650 | 1.616 | 25.8 |
| 14 | L6R2 | 4.064 | 0.359 | | |
| 15 | L7R1 | 3.073 | 0.873 | 1.535 | 55.7 |
| 16 | L7R2 | 1.899 | 0.233 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 8 are illustrated in Tables 30-1 and 30-2 together with a conic constant K.

TABLE 30-1

| SURFACE NUMBER | 3 | 4 | 5 | 6 |
|---|---|---|---|---|
| Y CURVATURE RADIUS R | 2.111 | 2.722 | 2.295 | 12.086 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.5301E−02 | −8.0254E−02 | −6.8182E−02 | −1.2015E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −7.7408E−03 | 2.3116E−03 | 7.2479E−04 | 1.9591E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.3436E−03 | −1.6925E−02 | −2.2935E−02 | −2.0332E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.6316E−03 | 1.6689E−02 | 2.8494E−02 | 1.1940E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.4860E−03 | −5.6005E−03 | −7.5647E−03 | −3.5743E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 6.2204E−04 | 0.0000E+00 | 4.0386E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 8.735 | 3.985 | −722.525 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −8.8773E−02 | 5.3867E−03 | −2.6940E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0682E−01 | 6.4425E−02 | 1.1476E−02 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1449E−01 | −9.4804E−02 | −1.9683E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1895E−01 | 7.3778E−02 | 6.7488E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3575E−02 | −3.1006E−02 | 2.2886E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.9848E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 30-2

| SURFACE NUMBER | 10 | 11 | 12 | 13 |
|---|---|---|---|---|
| Y CURVATURE RADIUS R | −913.348 | 41.657 | 9.910 | 2.908 |
| NORMALIZED RADIUS | 0.0000E+00 | 0.0000E+00 | 0.0000E+00 | 0.0000E+00 |
| CONIC CONSTANT K | 0.0000E+00 | −2.4828E−01 | −4.8405E−01 | −4.7064E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.2534E−01 | −1.1771E−02 | −1.4618E−02 |
| FOURTH-ORDER ASPHERIC COEFFICIENT | −3.6861E−02 | 4.6279E−01 | −1.0299E−01 | −3.7345E−03 |
| FIFTH-ORDER ASPHERIC COEFFICIENT | 0.0000E+00 | −1.1155E+00 | 2.0176E−01 | −3.8258E−02 |
| SIXTH-ORDER ASPHERIC COEFFICIENT | 2.7409E−02 | 1.5415E+00 | −5.5132E−01 | −2.0793E−02 |
| SEVENTH-ORDER ASPHERIC COEFFICIENT | 0.0000E+00 | −2.2780E+00 | 6.1218E−01 | 2.5582E−02 |
| EIGHTH-ORDER ASPHERIC COEFFICIENT | −3.1052E−02 | 4.0181E+00 | −1.9073E−01 | −1.3674E−02 |
| NINTH-ORDER ASPHERIC COEFFICIENT | 0.0000E+00 | −4.4700E+00 | −5.8618E−02 | 1.6608E−02 |
| TENTH-ORDER ASPHERIC COEFFICIENT | 7.3467E−03 | 1.7099E+00 | −5.2528E−02 | −1.1090E−02 |
| 11TH-ORDER ASPHERIC COEFFICIENT | 0.0000E+00 | 9.3510E−01 | 8.3521E−02 | −2.0491E−03 |
| 12TH-ORDER ASPHERIC COEFFICIENT | 2.2075E−03 | −7.0968E−01 | 1.2196E−02 | 3.3986E−03 |
| 13TH-ORDER ASPHERIC COEFFICIENT | 0.0000E+00 | −2.0946E−01 | −2.9745E−02 | −1.6082E−04 |
| 14TH-ORDER ASPHERIC COEFFICIENT | 0.0000E+00 | 1.2174E−01 | −6.7410E−03 | −2.9499E−04 |
| 15TH-ORDER ASPHERIC COEFFICIENT | 0.0000E+00 | 1.0177E−01 | 1.3023E−02 | −6.9270E−07 |
| 16TH-ORDER ASPHERIC COEFFICIENT | 0.0000E+00 | −4.6466E−02 | −3.2321E−03 | 1.7892E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.064 | 3.073 | 1.899 |
| NORMALIZED RADIUS | 0.0000E+00 | 0.0000E+00 | 0.0000E+00 |
| CONIC CONSTANT K | 1.3170E+00 | −1.4171E−01 | −7.0945E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.1499E−02 | −7.8361E−03 | 1.4795E−02 |
| FOURTH-ORDER ASPHERIC COEFFICIENT | −3.5326E−02 | −2.2140E−01 | −2.2684E−01 |
| FIFTH-ORDER ASPHERIC COEFFICIENT | 1.1868E−01 | 1.0026E−01 | 1.1365E−01 |
| SIXTH-ORDER ASPHERIC COEFFICIENT | −1.1820E−01 | 5.6336E−03 | 4.9447E−03 |
| SEVENTH-ORDER ASPHERIC COEFFICIENT | 2.9632E−02 | −5.5299E−03 | −2.1584E−02 |
| EIGHTH-ORDER ASPHERIC COEFFICIENT | 6.3567E−03 | −2.8771E−03 | 4.6476E−03 |
| NINTH-ORDER ASPHERIC COEFFICIENT | −2.1473E−03 | 8.2182E−04 | 3.9339E−04 |
| TENTH-ORDER ASPHERIC COEFFICIENT | −4.6375E−05 | 3.0933E−04 | 7.3496E−06 |
| 11TH-ORDER ASPHERIC COEFFICIENT | −1.5533E−04 | −3.8112E−05 | −3.6606E−05 |
| 12TH-ORDER ASPHERIC COEFFICIENT | −8.8473E−05 | −3.4150E−05 | −2.1138E−05 |
| 13TH-ORDER ASPHERIC COEFFICIENT | 4.9242E−05 | −3.7596E−07 | 4.7698E−06 |
| 14TH-ORDER ASPHERIC COEFFICIENT | 1.6031E−05 | 1.6578E−06 | 1.0091E−06 |
| 15TH-ORDER ASPHERIC COEFFICIENT | −6.1279E−06 | 5.8170E−07 | −1.2071E−07 |
| 16TH-ORDER ASPHERIC COEFFICIENT | 7.8334E−09 | −1.5860E−07 | −2.8194E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 8 are illustrated in Table 31.

TABLE 31

| | |
|---|---|
| FOCAL LENGTH | 4.60 |
| F-NUMBER | 1.6 |
| TOTAL LENGTH | 5.832 |
| ω | 40.0 |

A focal length of each lens in the numerical value example 8 is illustrated in Table 32.

TABLE 32

| | FOCAL LENGTH |
|---|---|
| L1 | 12.95 |
| L2 | 5.10 |
| L3 | −11.03 |
| L4 | −6343.16 |
| L5 | −20.09 |
| L6 | 13.57 |
| L7 | −12.53 |

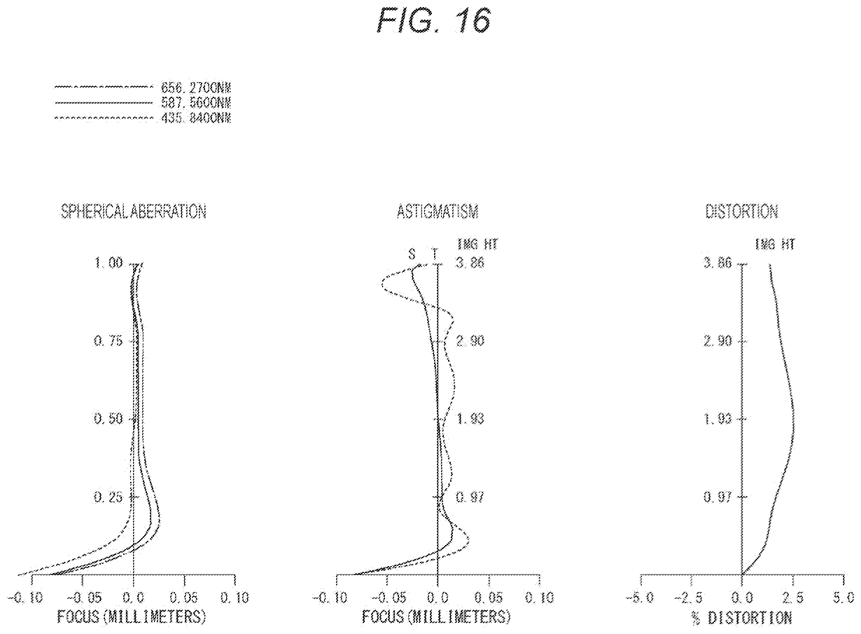

FIG. 16 is an aberration diagram of the numerical value example 8. In FIG. 16, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 8, and this has an excellent image forming performance.

### Ninth Embodiment

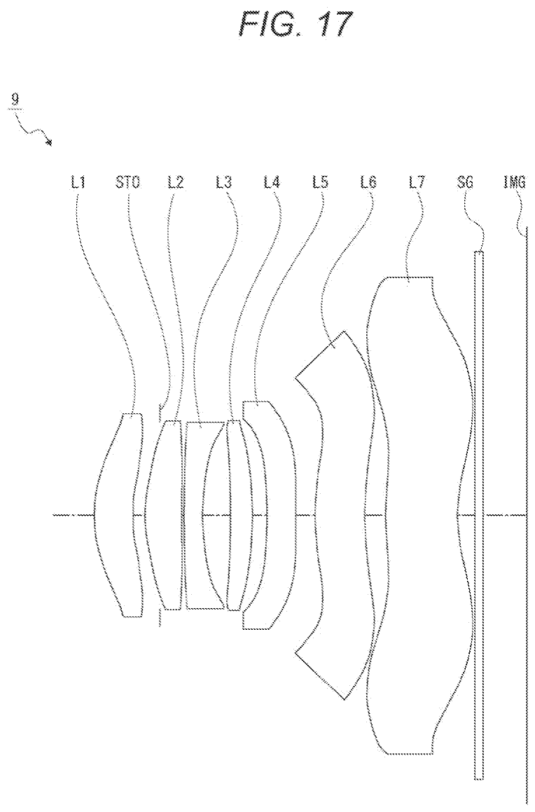

FIG. 17 illustrates a lens configuration of an imaging lens 9 in a ninth embodiment of the present technology.

The imaging lens 9 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged between the first lens L1 and the second lens L2.

Table 33 illustrates lens data of a numerical value example 9 in which specific numerical values are applied to the imaging lens 9.

TABLE 33

| SURFACE | | | | REFRACTIVE | ABBE |
|---|---|---|---|---|---|
| NUMBER | LENS | R | T | INDEX | NUMBER |
| 1 | L1R1 | 2.032 | 0.524 | 1.544 | 56.1 |
| 2 | L1R2 | 2.717 | 0.159 | | |
| 3 | | INFINITY | 0.200 | | |
| 4 | DIAPHRAGM | INFINITY | −0.200 | | |
| 5 | L2R1 | 2.271 | 0.495 | 1.544 | 56.1 |
| 6 | L2R2 | 12.813 | 0.030 | | |
| 7 | L3R1 | 13.265 | 0.250 | 1.616 | 25.8 |
| 8 | L3R2 | 3.693 | 0.376 | | |
| 9 | L4R1 | −25.000 | 0.300 | 1.544 | 56.1 |
| 10 | L4R2 | −5.836 | 0.196 | | |
| 11 | L5R1 | −10.127 | 0.388 | 1.616 | 25.8 |
| 12 | L5R2 | 27.784 | 0.259 | | |
| 13 | L6R1 | 3.481 | 0.671 | 1.616 | 25.8 |
| 14 | L6R2 | 4.097 | 0.283 | | |
| 15 | L7R1 | 3.079 | 0.968 | 1.535 | 55.7 |
| 16 | L7R2 | 2.000 | 0.233 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 9 are illustrated in Tables 34-1 and 34-2 together with a conic constant K.

TABLE 34-1

| SURFACE NUMBER | 1 | 2 | 5 | 6 |
|---|---|---|---|---|
| Y CURVATURE RADIUS R | 2.032 | 2.717 | 2.271 | 12.813 |
| NORMALIZED RADIUS | 0.0000E+00 | 0.0000E+00 | 0.0000E+00 | 0.0000E+00 |
| CONIC CONSTANT K | 0.0000E+00 | 0.0000E+00 | 0.0000E+00 | 0.0000E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.4927E−02 | −7.0992E−02 | −6.0362E−02 | −1.2017E−01 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −8.3280E−03 | 3.1919E−03 | 8.8576E−04 | 1.9210E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 5.2016E−03 | −1.7461E−02 | −2.2605E−02 | −2.0102E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −7.1274E−03 | 1.6167E−02 | 2.8365E−02 | 1.1971E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.4896E−03 | −5.6478E−03 | −7.2970E−03 | −3.6101E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 6.9447E−04 | 0.0000E+00 | 4.1194E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 13.265 | 3.693 | −25.000 |
| NORMALIZED RADIUS | 0.0000E+00 | 0.0000E+00 | 0.0000E+00 |
| CONIC CONSTANT K | 0.0000E+00 | 0.0000E+00 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −9.7059E−02 | 8.5011E−03 | −1.0974E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 2.0755E−01 | 5.6648E−02 | 9.9255E−03 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −2.1676E−01 | −9.1275E−02 | −2.2683E−02 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1919E−01 | 7.3940E−02 | 7.5732E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3630E−02 | −3.1227E−02 | 2.9625E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.9795E−03 | 6.9031E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 0.0000E+00 | 0.0000E+00 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 34-2

| SURFACE NUMBER | 10 | 11 | 12 | 13 |
|---|---|---|---|---|
| Y CURVATURE RADIUS R | −5.836 | −10.127 | 27.784 | 3.481 |
| NORMALIZED RADIUS | 0.0000E+00 | 0.0000E+00 | 0.0000E+00 | 0.0000E+00 |
| CONIC CONSTANT K | 0.0000E+00 | −6.2070E−01 | 2.8710E−01 | 4.3063E−01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.2445E−01 | −7.1595E−03 | −1.4663E−02 |
| FOURTH-ORDER ASPHERIC COEFFICIENT | −1.3897E−02 | 4.6065E−01 | −9.5559E−02 | 2.1319E−02 |
| FIFTH-ORDER ASPHERIC COEFFICIENT | 0.0000E+00 | −1.1065E+00 | 1.9555E−01 | −4.8481E−02 |
| SIXTH-ORDER ASPHERIC COEFFICIENT | 3.1236E−02 | 1.5387E+00 | −5.5237E−01 | −2.6231E−02 |
| SEVENTH-ORDER ASPHERIC COEFFICIENT | 0.0000E+00 | −2.2814E+00 | 6.1053E−01 | 2.6017E−02 |
| EIGHTH-ORDER ASPHERIC COEFFICIENT | −4.3402E−02 | 4.0161E+00 | −1.9113E−01 | −1.2298E−02 |
| NINTH-ORDER ASPHERIC COEFFICIENT | 0.0000E+00 | −4.4711E+00 | −5.8206E−02 | 1.6915E−02 |
| TENTH-ORDER ASPHERIC COEFFICIENT | 1.0636E−02 | 1.7093E+00 | −5.2143E−02 | −1.1030E−02 |
| 11TH-ORDER ASPHERIC COEFFICIENT | 0.0000E+00 | 9.3549E−01 | 8.3784E−02 | −2.0861E−03 |
| 12TH-ORDER ASPHERIC COEFFICIENT | 2.9484E−03 | −7.0904E−01 | 1.2283E−02 | 3.3694E−03 |
| 13TH-ORDER ASPHERIC COEFFICIENT | 0.0000E+00 | −2.0889E−01 | −2.9719E−02 | −1.7409E−04 |
| 14TH-ORDER ASPHERIC COEFFICIENT | 0.0000E+00 | 1.2215E−01 | −6.7245E−03 | −3.0006E−04 |
| 15TH-ORDER ASPHERIC COEFFICIENT | 0.0000E+00 | 1.0183E−01 | 1.3025E−02 | 9.0121E−07 |
| 16TH-ORDER ASPHERIC COEFFICIENT | 0.0000E+00 | −4.6713E−02 | −3.2451E−03 | 1.9242E−05 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 4.097 | 3.079 | 2.000 |
| NORMALIZED RADIUS | 0.0000E+00 | 0.0000E+00 | 0.0000E+00 |
| CONIC CONSTANT K | 1.4227E+00 | −1.4094E−01 | −6.9260E−01 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −3.3875E−02 | −1.4480E−02 | 2.5372E−02 |
| FOURTH-ORDER ASPHERIC COEFFICIENT | −4.5642E−02 | −2.1614E−01 | −2.2654E−01 |
| FIFTH-ORDER ASPHERIC COEFFICIENT | 1.2656E−01 | 9.9931E−02 | 1.1160E−01 |
| SIXTH-ORDER ASPHERIC COEFFICIENT | −1.1838E−01 | 5.3894E−03 | 5.6062E−03 |
| SEVENTH-ORDER ASPHERIC COEFFICIENT | 2.8879E−02 | −5.5553E−03 | −2.1408E−02 |
| EIGHTH-ORDER ASPHERIC COEFFICIENT | 6.2424E−03 | −2.8671E−03 | 4.6499E−03 |
| NINTH-ORDER ASPHERIC COEFFICIENT | −2.1165E−03 | 8.2436E−04 | 3.8252E−04 |
| TENTH-ORDER ASPHERIC COEFFICIENT | −2.3895E−05 | 3.0948E−04 | 3.8295E−06 |
| 11TH-ORDER ASPHERIC COEFFICIENT | −1.4938E−04 | −3.7990E−05 | −3.7092E−05 |
| 12TH-ORDER ASPHERIC COEFFICIENT | −8.9426E−05 | −3.4175E−05 | −2.1189E−05 |
| 13TH-ORDER ASPHERIC COEFFICIENT | 4.8488E−05 | −3.9183E−07 | 4.7817E−06 |
| 14TH-ORDER ASPHERIC COEFFICIENT | 1.5848E−05 | 1.6542E−06 | 1.0175E−06 |
| 15TH-ORDER ASPHERIC COEFFICIENT | −6.1183E−06 | 5.8193E−07 | −1.1714E−07 |
| 16TH-ORDER ASPHERIC COEFFICIENT | 2.5648E−08 | −1.5783E−07 | −2.7119E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 9 are illustrated in Table 35.

TABLE 35

| | |
|---|---|
| FOCAL LENGTH | 4.58 |
| F-NUMBER | 1.7 |
| TOTAL LENGTH | 5.832 |
| ω | 40.3 |

A focal length of each lens in the numerical value example 9 is illustrated in Table 36.

TABLE 36

| | FOCAL LENGTH |
|---|---|
| L1 | 11.64 |
| L2 | 4.98 |
| L3 | −8.34 |
| L4 | 13.88 |
| L5 | −11.92 |
| L6 | 26.35 |
| L7 | −15.49 |

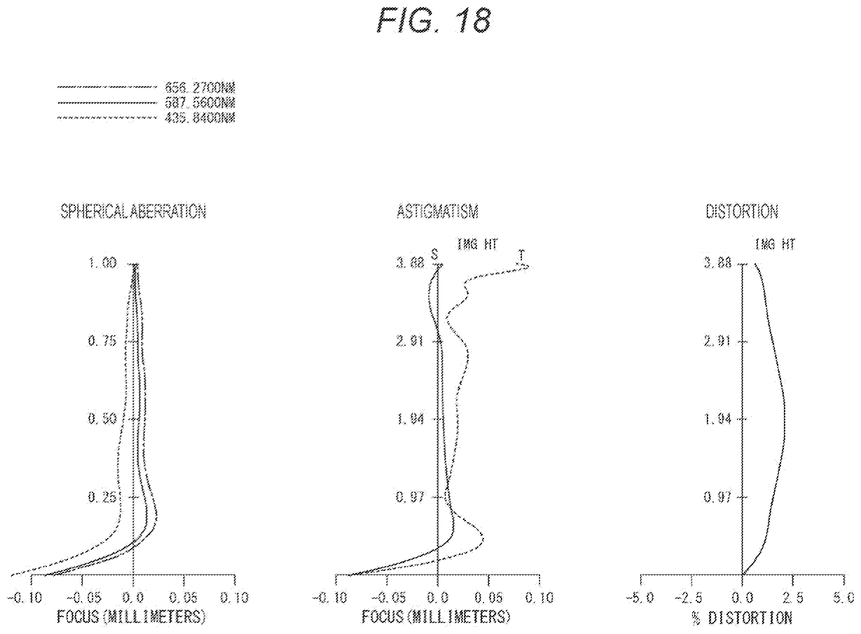

FIG. 18 is an aberration diagram of the numerical value example 9. In FIG. 18, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 9, and this has an excellent image forming performance.

### Tenth Embodiment

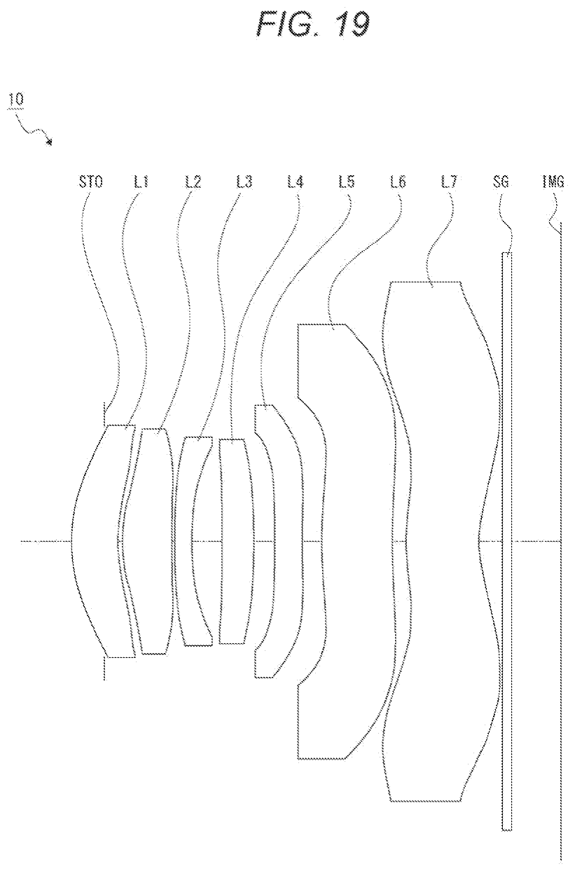

FIG. 19 illustrates a lens configuration of an imaging lens 10 in a tenth embodiment of the present technology.

The imaging lens 10 includes a first lens L1 having a positive refractive power with a convex surface facing an object side, a second lens L2 having a positive refractive power, a third lens L3 having a negative refractive power, a fourth lens L4 having a positive refractive power with a concave surface facing the object side, a fifth lens L5 having a negative refractive power, a sixth lens L6 having a positive refractive power with a concave surface facing an image side, and a seventh lens L7 having a negative refractive power in the vicinity of an optical axis arranged in order from the object side to the image side. The seventh lens L7 includes a surface on the image side formed into an aspherical shape with an inflection point.

A seal glass SG is arranged between the seventh lens L7 and an image surface IMG. An aperture diaphragm STO is arranged on the object side of the first lens L1.

Table 37 illustrates lens data of a numerical value example 10 in which specific numerical values are applied to the imaging lens 10.

TABLE 37

| SURFACE | | | | REFRACTIVE | ABBE |
|---|---|---|---|---|---|
| NUMBER | LENS | R | T | INDEX | NUMBER |
| 1 | | INFINITY | 0.390 | | |
| 2 | DIAPHRAGM | INFINITY | −0.390 | | |
| 3 | L1R1 | 2.080 | 0.545 | 1.544 | 56.1 |
| 4 | L1R2 | 1.895 | 0.056 | | |
| 5 | L2R1 | 1.804 | 0.593 | 1.544 | 56.1 |
| 6 | L2R2 | 23.505 | 0.030 | | |
| 7 | L3R1 | 8.021 | 0.210 | 1.671 | 19.2 |
| 8 | L3R2 | 3.727 | 0.357 | | |
| 9 | L4R1 | −78.500 | 0.379 | 1.544 | 56.1 |
| 10 | L4R2 | −10.413 | 0.250 | | |
| 11 | L5R1 | 47.165 | 0.327 | 1.644 | 22.5 |
| 12 | L5R2 | 10.761 | 0.234 | | |
| 13 | L6R1 | 8.067 | 0.842 | 1.616 | 25.8 |
| 14 | L6R2 | 7.852 | 0.166 | | |
| 15 | L7R1 | 2.409 | 0.867 | 1.535 | 55.7 |
| 16 | L7R2 | 1.735 | 0.276 | | |
| 17 | SG | INFINITY | 0.110 | 1.517 | 64.2 |
| 18 | | INFINITY | 0.590 | | |
| 19 | IMAGE | INFINITY | 0.000 | | |
| | SURFACE | | | | |

The aspherical coefficient and the like of each surface of the lens in the numerical value example 10 are illustrated in Tables 38-1 and 38-2 together with a conic constant K.

TABLE 38-1

| SURFACE NUMBER | 3 | 4 | 5 | 6 |
|---|---|---|---|---|
| Y CURVATURE RADIUS R | 2.080 | 1.895 | 1.804 | 23.505 |
| NORMALIZED RADIUS | 0.0000E+00 | 0.0000E+00 | 0.0000E+00 | 0.0000E+00 |
| CONIC CONSTANT K | −1.9756E−02 | −5.5911E+00 | −5.4618E+00 | −1.0000E+01 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | 0.0000E+00 | 0.0000E+00 | 0.0000E+00 |
| FOURTH-ORDER ASPHERIC COEFFICIENT | −1.7592E−02 | −5.7817E−02 | −2.3909E−02 | −5.3277E−02 |
| FIFTH-ORDER ASPHERIC COEFFICIENT | 0.0000E+00 | 0.0000E+00 | 0.0000E+00 | 0.0000E+00 |
| SIXTH-ORDER ASPHERIC COEFFICIENT | −2.7448E−03 | 6.8820E−03 | −2.3236E−02 | 1.1957E−01 |
| SEVENTH-ORDER ASPHERIC COEFFICIENT | 0.0000E+00 | 0.0000E+00 | 0.0000E+00 | 0.0000E+00 |
| EIGHTH-ORDER ASPHERIC COEFFICIENT | 4.6970E−03 | −2.9985E−02 | −9.1387E−03 | −1.8723E−01 |
| NINTH-ORDER ASPHERIC COEFFICIENT | 0.0000E+00 | 0.0000E+00 | 0.0000E+00 | 0.0000E+00 |
| TENTH-ORDER ASPHERIC COEFFICIENT | −6.4607E−03 | 3.4621E−02 | 1.9284E−02 | 1.3069E−01 |
| 11TH-ORDER ASPHERIC COEFFICIENT | 0.0000E+00 | 0.0000E+00 | 0.0000E+00 | 0.0000E+00 |
| 12TH-ORDER ASPHERIC COEFFICIENT | 1.7167E−03 | −1.4164E−02 | −4.9176E−03 | −4.3335E−02 |
| 13TH-ORDER ASPHERIC COEFFICIENT | 0.0000E+00 | 0.0000E+00 | 0.0000E+00 | 0.0000E+00 |
| 14TH-ORDER ASPHERIC COEFFICIENT | 0.0000E+00 | 2.4515E−03 | 0.0000E+00 | 5.4635E−03 |
| 15TH-ORDER ASPHERIC COEFFICIENT | 0.0000E+00 | 0.0000E+00 | 0.0000E+00 | 0.0000E+00 |
| 16TH-ORDER ASPHERIC COEFFICIENT | 0.0000E+00 | 0.0000E+00 | 0.0000E+00 | 0.0000E+00 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 7 | 8 | 9 |
|---|---|---|---|
| Y CURVATURE RADIUS R | 8.021 | 3.727 | −78.500 |
| NORMALIZED RADIUS | 0.0000E+00 | 0.0000E+00 | 0.0000E+00 |
| CONIC CONSTANT K | 1.0000E+01 | −5.6531E−01 | 0.0000E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | 0.0000E+00 | 0.0000E+00 | 0.0000E+00 |
| FOURTH-ORDER ASPHERIC COEFFICIENT | −4.3415E−02 | −5.6535E−04 | −1.8063E−02 |
| FIFTH-ORDER ASPHERIC COEFFICIENT | 0.0000E+00 | 0.0000E+00 | 0.0000E+00 |
| SIXTH-ORDER ASPHERIC COEFFICIENT | 1.4398E−01 | 6.2096E−02 | −7.3813E−04 |
| SEVENTH-ORDER ASPHERIC COEFFICIENT | 0.0000E+00 | 0.0000E+00 | 0.0000E+00 |
| EIGHTH-ORDER ASPHERIC COEFFICIENT | −1.8796E−01 | −8.7594E−02 | −4.4977E−03 |
| NINTH-ORDER ASPHERIC COEFFICIENT | 0.0000E+00 | 0.0000E+00 | 0.0000E+00 |
| TENTH-ORDER ASPHERIC COEFFICIENT | 1.1943E−01 | 7.0994E−02 | −2.7876E−03 |
| 11TH-ORDER ASPHERIC COEFFICIENT | 0.0000E+00 | 0.0000E+00 | 0.0000E+00 |
| 12TH-ORDER ASPHERIC COEFFICIENT | −3.3814E−02 | −2.9903E−02 | 5.4918E−03 |
| 13TH-ORDER ASPHERIC COEFFICIENT | 0.0000E+00 | 0.0000E+00 | 0.0000E+00 |
| 14TH-ORDER ASPHERIC COEFFICIENT | 3.4059E−03 | 6.7355E−03 | 0.0000E+00 |
| 15TH-ORDER ASPHERIC COEFFICIENT | 0.0000E+00 | 0.0000E+00 | 0.0000E+00 |
| 16TH-ORDER ASPHERIC COEFFICIENT | 1.9945E−05 | 7.4849E−05 | 0.0000E+00 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

TABLE 38-2

| SURFACE NUMBER | 10 | 11 | 12 | 13 |
|---|---|---|---|---|
| Y CURVATURE RADIUS R | −10.413 | 47.165 | 10.761 | 8.067 |
| NORMALIZED RADIUS | 0.0000E+00 | 0.0000E+00 | 0.0000E+00 | 0.0000E+00 |
| CONIC CONSTANT K | 0.0000E+00 | 1.0000E+01 | −1.0000E+01 | 3.8532E+00 |
| FIRST-ORDER ASPHERIC COEFFICIENT | 0.0000E+00 | 0.0000E+00 | 0.0000E+00 | 0.0000E+00 |
| SECOND-ORDER ASPHERIC COEFFICIENT | 0.0000E+00 | 0.0000E+00 | 0.0000E+00 | 0.0000E+00 |
| THIRD-ORDER ASPHERIC COEFFICIENT | 0.0000E+00 | −1.2213E−01 | −2.7327E−02 | 3.7872E−02 |
| FOURTH-ORDER ASPHERIC COEFFICIENT | −1.8890E−02 | 4.0760E−01 | 2.2520E−02 | −1.8297E−02 |
| FIFTH-ORDER ASPHERIC COEFFICIENT | 0.0000E+00 | −9.6325E−01 | 4.5155E−02 | 5.4994E−03 |
| SIXTH-ORDER ASPHERIC COEFFICIENT | 3.4660E−03 | 1.3901E+00 | −4.7814E−01 | −7.0038E−02 |
| SEVENTH-ORDER ASPHERIC COEFFICIENT | 0.0000E+00 | −2.2930E+00 | 6.1744E−01 | 3.3650E−02 |
| EIGHTH-ORDER ASPHERIC COEFFICIENT | −1.2440E−02 | 4.0677E+00 | −2.0392E−01 | −4.1920E−03 |
| NINTH-ORDER ASPHERIC COEFFICIENT | 0.0000E+00 | −4.4382E+00 | −6.3805E−02 | 1.6758E−02 |
| TENTH-ORDER ASPHERIC COEFFICIENT | 1.9887E−03 | 1.7067E+00 | −5.0642E−02 | −1.2482E−02 |
| 11TH-ORDER ASPHERIC COEFFICIENT | 0.0000E+00 | 9.1691E−01 | 8.6075E−02 | −2.8832E−03 |
| 12TH-ORDER ASPHERIC COEFFICIENT | 2.8500E−03 | −7.2301E−01 | 1.2858E−02 | 3.3279E−03 |
| 13TH-ORDER ASPHERIC COEFFICIENT | 0.0000E+00 | −2.0936E−01 | −3.0054E−02 | −7.8168E−05 |
| 14TH-ORDER ASPHERIC COEFFICIENT | 0.0000E+00 | 1.2990E−01 | −7.0680E−03 | −2.2398E−04 |
| 15TH-ORDER ASPHERIC COEFFICIENT | 0.0000E+00 | 1.0815E−01 | 1.2850E−02 | 2.4694E−05 |
| 16TH-ORDER ASPHERIC COEFFICIENT | 0.0000E+00 | −5.1349E−02 | −3.1076E−03 | 6.2723E−06 |
| 17TH-ORDER ASPHERIC COEFFICIENT | 0.0000E+00 | 0.0000E+00 | 0.0000E+00 | 0.0000E+00 |
| 18TH-ORDER ASPHERIC COEFFICIENT | 0.0000E+00 | 0.0000E+00 | 0.0000E+00 | 0.0000E+00 |
| 19TH-ORDER ASPHERIC COEFFICIENT | 0.0000E+00 | 0.0000E+00 | 0.0000E+00 | 0.0000E+00 |
| 20TH-ORDER ASPHERIC COEFFICIENT | 0.0000E+00 | 0.0000E+00 | 0.0000E+00 | 0.0000E+00 |

| SURFACE NUMBER | 14 | 15 | 16 |
|---|---|---|---|
| Y CURVATURE RADIUS R | 7.852 | 2.409 | 1.735 |
| NORMALIZED RADIUS | 0.0000E+00 | 0.0000E+00 | 0.0000E+00 |
| CONIC CONSTANT K | 7.9137E+00 | −5.0618E−01 | −1.2579E+00 |
| FIRST-ORDER ASPHERIC COEFFICIENT | 0.0000E+00 | 0.0000E+00 | 0.0000E+00 |
| SECOND-ORDER ASPHERIC COEFFICIENT | 0.0000E+00 | 0.0000E+00 | 0.0000E+00 |
| THIRD-ORDER ASPHERIC COEFFICIENT | −1.4049E−02 | −3.6720E−02 | 2.1866E−02 |
| FOURTH-ORDER ASPHERIC COEFFICIENT | −7.4593E−02 | −2.0858E−01 | −2.3856E−01 |
| FIFTH-ORDER ASPHERIC COEFFICIENT | 1.4222E−01 | 8.5298E−02 | 1.2838E−01 |
| SIXTH-ORDER ASPHERIC COEFFICIENT | −1.1113E−01 | 9.5862E−03 | 4.0194E−04 |
| SEVENTH-ORDER ASPHERIC COEFFICIENT | 2.5318E−02 | −4.7218E−03 | −2.0625E−02 |
| EIGHTH-ORDER ASPHERIC COEFFICIENT | 4.7038E−03 | −2.8701E−03 | 4.7572E−03 |
| NINTH-ORDER ASPHERIC COEFFICIENT | −1.8258E−03 | 7.7048E−04 | 3.6413E−04 |
| TENTH-ORDER ASPHERIC COEFFICIENT | 1.7727E−04 | 2.8599E−04 | −4.7370E−06 |
| 11TH-ORDER ASPHERIC COEFFICIENT | −1.2898E−04 | −4.1956E−05 | −3.8337E−05 |
| 12TH-ORDER ASPHERIC COEFFICIENT | −1.0347E−04 | −3.3902E−05 | −2.1161E−05 |
| 13TH-ORDER ASPHERIC COEFFICIENT | 4.4916E−05 | 4.8495E−08 | 4.8393E−06 |
| 14TH-ORDER ASPHERIC COEFFICIENT | 1.5795E−05 | 1.8145E−08 | 1.0347E−06 |
| 15TH-ORDER ASPHERIC COEFFICIENT | −5.7042E−06 | 6.2375E−07 | −1.1738E−07 |
| 16TH-ORDER ASPHERIC COEFFICIENT | −2.3029E−08 | −1.7893E−07 | −2.5442E−08 |
| 17TH-ORDER ASPHERIC COEFFICIENT | 0.0000E+00 | 0.0000E+00 | 0.0000E+00 |
| 18TH-ORDER ASPHERIC COEFFICIENT | 0.0000E+00 | 0.0000E+00 | 0.0000E+00 |
| 19TH-ORDER ASPHERIC COEFFICIENT | 0.0000E+00 | 0.0000E+00 | 0.0000E+00 |
| 20TH-ORDER ASPHERIC COEFFICIENT | 0.0000E+00 | 0.0000E+00 | 0.0000E+00 |

The focal length, f-number, total length, and half angle of view ω of the numerical value example 10 are illustrated in Table 39.

TABLE 39

| | |
|---|---|
| FOCAL LENGTH | 4.60 |
| F-NUMBER | 1.6 |
| TOTAL LENGTH | 5.833 |
| ω | 40.2 |

A focal length of each lens in the numerical value example 10 is illustrated in Table 40.

TABLE 40

| | FOCAL LENGTH |
|---|---|
| L1 | 1015.00 |
| L2 | 3.55 |
| L3 | −10.16 |
| L4 | 21.90 |
| L5 | −21.48 |
| L6 | 932.17 |
| L7 | −21.02 |

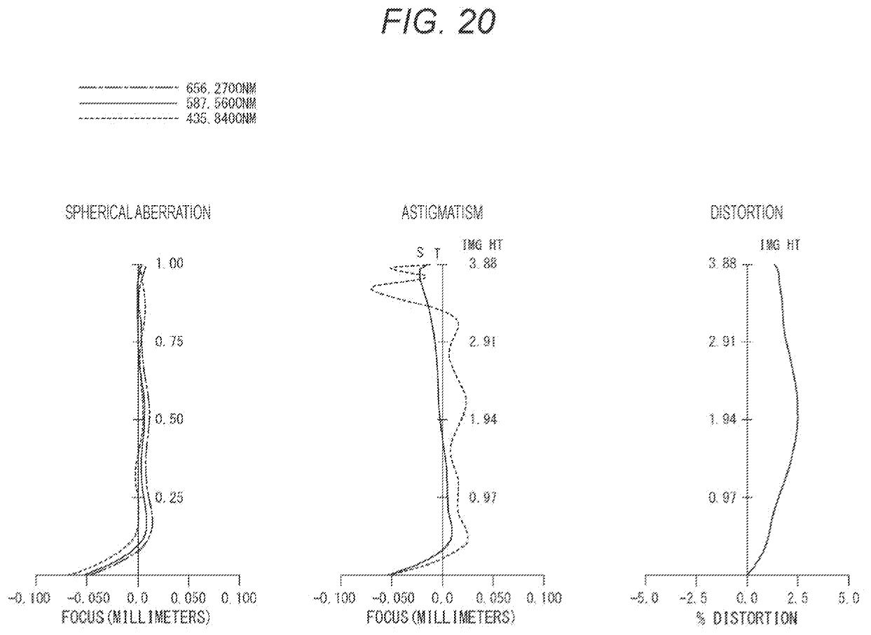

FIG. 20 is an aberration diagram of the numerical value example 10. In FIG. 20, in spherical aberration, a solid line indicates a value of a d-line (587.56 nm), a dotted line indicates a value of a c-line (656.27 nm), a dashed-dotted line indicates a value of a g-line (435.84 nm); in astigmatism, a solid line indicates a value of a sagittal image surface of the d-line, a broken line indicates a value of a meridional image surface of the d-line; and in distortion aberration, a value of the d-line is indicated.

From each aberration diagram, it is clear that various aberrations are excellently corrected in the numerical value example 10, and this has an excellent image forming performance.

### [Each Value in Conditional Expression of Imaging Lens]

Each value in a conditional expression of the imaging lens of the present technology is described below.

Table 41 illustrates each value in conditional expressions (1) to (8) in the numerical value examples 1 to 10 of the imaging lenses 1 to 10.

TABLE 41

| | | EXAMPLE 1 | EXAMPLE 2 | EXAMPLE 3 |
|---|---|---|---|---|
| CONDITIONAL | f1/f | 43.50 | 1.09 | 2.45 |
| EXPRESSION (1) | | | | |
| CONDITIONAL | f2/f | 0.78 | 3.86 | 1.23 |
| EXPRESSION (2) | | | | |
| CONDITIONAL | \|f45\|/f | 42.63 | 25.03 | 18.33 |
| EXPRESSION (3) | | | | |
| CONDITIONAL | f6/f | 133.14 | 22.98 | 10.13 |
| EXPRESSION (4) | | | | |
| CONDITIONAL | f6/f7 | −21.62 | −4.34 | −3.70 |
| EXPRESSION (5) | | | | |
| CONDITIONAL | \|R7/f\| | 17.07 | 10.76 | 149.55 |
| EXPRESSION (6) | | | | |
| CONDITIONAL | \|(R11 + R12)/ | 38.63 | 316.29 | 27.08 |
| EXPRESSION (7) | (R11 − R12)\| | | | |
| CONDITIONAL | v d(L3) < v d(L5) < | 19.2/22.4/26.0 | 19.2/22.4/26.0 | 19.2/22.4/26.0 |
| EXPRESSION (8) | v d(L6) | | | |
| | | EXAMPLE 4 | EXAMPLE 5 | EXAMPLE 6 |
| CONDITIONAL | f1/f | 2.75 | 2.83 | 2.46 |
| EXPRESSION (1) | | | | |
| CONDITIONAL | f2/f | 1.13 | 1.11 | 1.20 |
| EXPRESSION (2) | | | | |
| CONDITIONAL | \|f45\|/f | 4.04 | 4.37 | 217.46 |
| EXPRESSION (3) | | | | |
| CONDITIONAL | f6/f | 2.87 | 2.96 | 9.05 |
| EXPRESSION (4) | | | | |
| CONDITIONAL | f6/f7 | −0.35 | −0.44 | −3.11 |
| EXPRESSION (5) | | | | |
| CONDITIONAL | \|R7/f\| | 218.51 | 218.52 | 176.20 |
| EXPRESSION (6) | | | | |
| CONDITIONAL | \|(R11 + R12)/ | 5.87 | 6.05 | 22.70 |
| EXPRESSION (7) | (R11 − R12)\| | | | |
| CONDITIONAL | v d(L3) < v d(L5) < | 19.2/22.4/26.0 | 19.2/22.4/26.0 | 19.2/22.4/26.0 |
| EXPRESSION (8) | v d(L6) | | | |

| | | EXAMPLE 7 | EXAMPLE 8 | EXAMPLE 9 | EXAMPLE 10 |
|---|---|---|---|---|---|
| CONDITIONAL | f1/f | 2.82 | 2.81 | 2.54 | 220.54 |
| EXPRESSION (1) | | | | | |
| CONDITIONAL | f2/f | 1.11 | 1.11 | 1.09 | 0.77 |
| EXPRESSION (2) | | | | | |
| CONDITIONAL | \|f45\|/f | 4.37 | 4.35 | 20.57 | 68313.64 |
| EXPRESSION (3) | | | | | |
| CONDITIONAL | f6/f | 2.99 | 2.95 | 5.76 | 206.43 |
| EXPRESSION (4) | | | | | |
| CONDITIONAL | f6/f7 | −1.09 | −1.08 | −1.70 | −45.33 |
| EXPRESSION (5) | | | | | |
| CONDITIONAL | \|R7/f\| | 215.44 | 157.01 | 5.46 | 17.06 |
| EXPRESSION (6) | | | | | |
| CONDITIONAL | \|(R11 + R12)/ | 6.10 | 6.03 | 12.30 | 74.17 |
| EXPRESSION (7) | (R11 − R12)\| | | | | |
| CONDITIONAL | v d(L3) < v d(L5) < | 19.2/22.4/26.0 | 19.2/22.4/26.0 | 26.0/26.0/26.0 | 19.2/22.4/26.0 |
| EXPRESSION (8) | v d(L6) | | | | |

As is clear from Table 41, the imaging lenses 1 to 10 are designed to satisfy conditional expressions (1) to (8).

### [Configuration of Imaging Device]

In the imaging device of the present technology, the imaging lens is provided with the first lens having the positive refractive power with the convex surface facing the object side, the second lens having the positive refractive power, the third lens having the negative refractive power, the fourth lens having the positive refractive power or the negative refractive power with the concave surface facing the object side, the fifth lens having the positive refractive power or the negative refractive power, the sixth lens having the positive refractive power with the concave surface facing the image side, and the seventh lens having the negative refractive power in the vicinity of the optical axis, the surface on the image side of which is formed into the aspherical shape having the inflection point in order from the object side to the image side.

In this manner, in the imaging device, the imaging lens has a lens configuration of seven lenses in total, each lens arranged to have an optimal refractive power and formed into a lens shape in which an aspheric surface is effectively used, so that it becomes possible to excellently correct various aberrations while securing a large diameter and miniaturization and improve performance.

Furthermore, regarding each lens, it becomes possible to correct the various aberrations more excellently while securing the large diameter and miniaturization by combining optimum glass materials.

Especially, by forming the surface on the object side of the fourth lens into a concave shape, it is possible to correct the coma aberration and field curvature while reducing the eccentric sensitivity.

### <One Embodiment of Imaging Device>

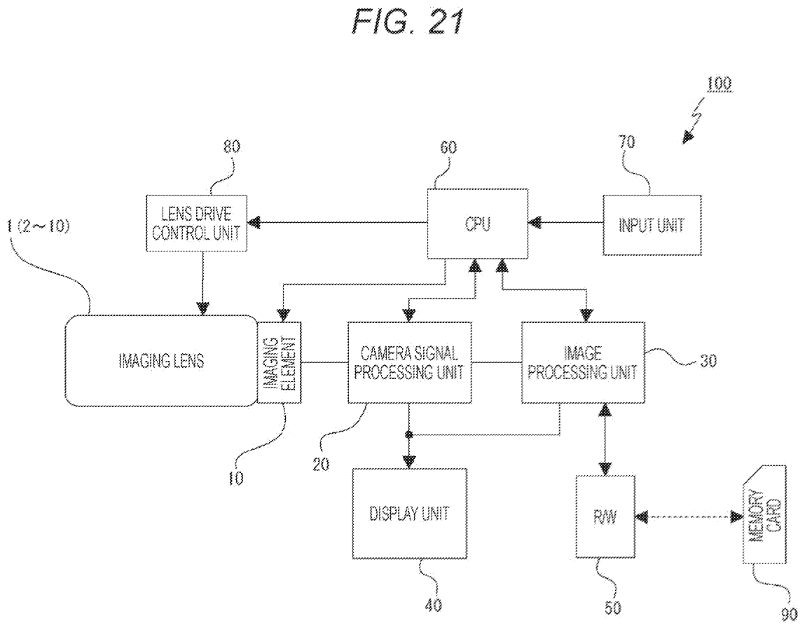

FIG. 21 is a block diagram of one embodiment of the imaging device of the present technology.

An imaging device 100 includes an imaging element 10 having a photoelectric conversion function of converting captured light into an electric signal, a camera signal processing unit 20 that performs signal processing such as analog-to-digital conversion of an imaged image signal, and an image processing unit 30 that performs record/reproduction processing of the image signal. Furthermore, the imaging device 100 is provided with a display unit 40 that displays an imaged image and the like, a reader/writer (R/W) 50 that writes and reads the image signal in and from a memory 90, a central processing unit (CPU) 60 that controls an entire imaging device 100, an input unit 70 such as various switches on which a user performs a required operation, and a lens drive control unit 80 that controls drive of a lens group (movable group).

The camera signal processing unit 20 performs various types of signal processing such as conversion of an output signal from the imaging element 10 into a digital signal, noise removal, image quality correction, and conversion into a luminance/color difference signal.

The image processing unit 30 performs compression encoding/decompression decoding processing of the image signal based on a predetermined image data format, conversion processing of data specification such as resolution and the like.

The display unit 40 has a function of displaying various data such as an operating state of the user on the input unit 70 and the imaged image.

The R/W 50 writes the image data encoded by the image processing unit 30 in the memory 90 and reads the image data recorded in the memory 90.

The CPU 60 serves as a control processing unit that controls each circuit block provided in the imaging device 100, and controls each circuit block on the basis of an instruction input signal and the like from the input unit 70.

The input unit 70 outputs the instruction input signal according to the user operation to the CPU 60.

The lens drive control unit 80 controls a motor and the like not illustrated that drives the lens group on the basis of a control signal from the CPU 60.

The memory 90 is, for example, a semiconductor memory attachable to and detachable from a slot connected to the R/W 50. Note that, it is also possible that the memory 90 is not attachable to and detachable from the slot, and is incorporated in the imaging device 100.

The operation in the imaging device 100 is hereinafter described.

In a standby state for imaging, under the control of the CPU 60, the imaged image signal is output to the display unit 40 via the camera signal processing unit 20 and displayed as a camera through image.

When imaging is performed by the instruction input signal from the input unit 70, the imaged image signal is output from the camera signal processing unit 20 to the image processing unit 30, subjected to the compression encoding processing, and converted into digital data in a predetermined data format. The converted data is output to the R/W 50 and written in the memory 90.

Focusing is performed by moving a focus lens group by the lens drive control unit 80 on the basis of the control signal from the CPU 60.

In a case of reproducing the image data recorded in the memory 90, predetermined image data is read from the memory 90 by the R/W 50 in response to the operation on the input unit 70, and the decompression decoding processing is performed thereon by the image processing unit 30, then a reproduced image signal is output to the display unit 40 and a reproduced image is displayed.

Note that, in the present technology, the term “imaging” refers to processing including only a part of or all of a series of processing starting from photoelectric conversion processing of converting the captured light into the electric signal by the imaging element 10, processing such as the conversion of the output signal from the imaging element 10 into the digital signal, the noise removal, the image quality correction, and the conversion into the luminance/color difference signal by the camera signal processing unit 20, the compression encoding/decompression decoding processing of the image signal based on a predetermined image data format and the conversion processing of the data specification such as the resolution by the image processing unit 30, until writing processing of the image signal in the memory 90 by the R/W 50.

That is, the term “imaging” may refer only to the photoelectric conversion processing that converts the captured light into the electric signal by the imaging element 10, may refer to processing from the photoelectric conversion processing that converts the captured light into the electric signal by the imaging element 10 to processing such as the conversion of the output signal from the imaging element 10 into the digital signal, the noise removal, the image quality correction, and the conversion into the luminance/color difference signal by the camera signal processing unit 20, may refer to processing from the photoelectric conversion processing that converts the captured light into the electric signal by the imaging element 10 through the processing such as the conversion of the output signal from the imaging element 10 into the digital signal, the noise removal, the image quality correction, and the conversion into the luminance/color difference signal by the camera signal processing unit 20 to the compression encoding/decompression decoding processing of the image signal based on a predetermined image data format and the conversion processing of the data specification such as the resolution by the image processing unit 30, may refer to processing from the photoelectric conversion processing of converting the captured light into the electric signal by the imaging element 10, through the processing such as the conversion of the output signal from the imaging element 10 into the digital signal, the noise removal, the image quality correction, and the conversion into the luminance/color difference signal by the camera signal processing unit 20, and the compression encoding/decompression decoding processing of the image signal based on a predetermined image data format and the conversion processing of the data specification such as the resolution by the image processing unit 30, and may refer to the processing until the writing processing of the image signal in the memory 90 by the R/W 50. In the above-described processing, the order of each processing may be appropriately changed.

Furthermore, in the present technology, the imaging device 100 may include only a part of or all of the imaging element 10, the camera signal processing unit 20, the image processing unit 30, and the R/W 50 that perform the above-described processing.

### [Others]

In the imaging lens of the present technology and the imaging device of the present technology, other optical elements such as a lens having no refractive power may be arranged in addition to the first lens L1 to the seventh lens L7. In this case, the lens configuration of the imaging lens of the present technology is substantially made the lens configuration of seven lenses of the first lens L1 to the seventh lens L7.

Note that, the imaging device described above may be widely applied to a digital still camera, a digital video camera, a camera unit of a digital input/output device such as a mobile phone with an incorporated camera, and a mobile terminal such as a tablet with an incorporated camera and the like.

### Application Example 1

The technology according to the present disclosure may be applied to various products. For example, the technology according to the present disclosure may be applied to a capsule endoscope.

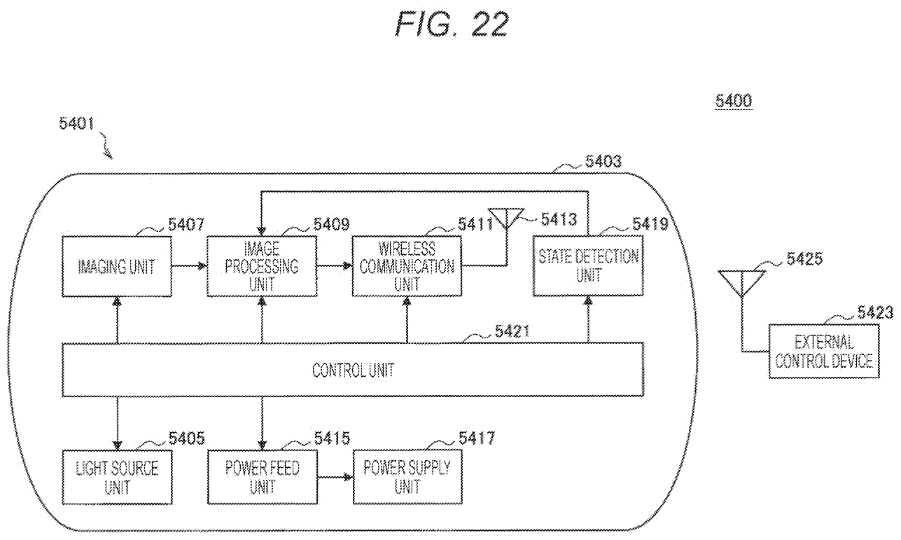

FIG. 22 is a view illustrating a schematic configuration example of an in-vivo information obtaining system 5400 to which the technology according to the present disclosure may be applied. With reference to FIG. 22, the in-vivo information obtaining system 5400 includes a capsule endoscope 5401 and an external control device 5423 that comprehensively controls an operation of the in-vivo information obtaining system 5400. At the time of examination, the capsule endoscope 5401 is swallowed by a patient. The capsule endoscope 5401 has an imaging function and a wireless communication function and sequentially images images in organs (hereinafter, also referred to as in-vivo images) at a predetermined interval while moving in the organs such as the stomach and the intestines by peristaltic movement and the like until being naturally discharged from the patient, and sequentially wirelessly transmits information regarding the in-vivo images to the external control device 5423 outside the body. The external control device 5423 generates image data for displaying the in-vivo image on a display device (not illustrated) on the basis of the received information regarding the in-vivo image. In the in-vivo information obtaining system 5400, it is possible to obtain as needed the image of the inside of the patient's body from when the capsule endoscope 5401 is swallowed until this is discharged in this manner.

Configurations and functions of the capsule endoscope 5401 and the external control device 5423 are described in further detail. As illustrated, the capsule endoscope 5401 has functions of a light source unit 5405, an imaging unit 5407, an image processing unit 5409, a wireless communication unit 5411, a power feed unit 5415, a power supply unit 5417, a state detection unit 5419, and a control unit 5421 in a capsule-shaped casing 5403.

The light source unit 5405 includes a light source such as, for example, a light emitting diode (LED), and irradiates an imaging visual field of the imaging unit 5407 with light.

The imaging unit 5407 includes an optical system including an imaging element and a plurality of lenses provided on a preceding stage of the imaging element. Reflected light (hereinafter referred to as observation light) of the light applied to body tissue being an observation target is condensed by the optical system and is incident on the imaging element. The imaging element receives the observation light and photoelectrically converts the same to generate an electric signal corresponding to the observation light, that is, an image signal corresponding to an observation image. The image signal generated by the imaging unit 5407 is provided to the image processing unit 5409. Note that, as the imaging element of the imaging unit 5407, various types of well-known imaging elements such as a complementary metal oxide semiconductor (CMOS) image sensor, or a charge coupled device (CCD) image sensor may be used.

The image processing unit 5409 includes a processor such as a central processing unit (CPU) and a graphics processing unit (GPU), and performs various types of signal processing on the image signal generated by the imaging unit 5407. The signal processing may be minimum processing (for example, image data compression, frame rate conversion, data rate conversion, and/or format conversion and the like) for transmitting the image signal to the external control device 5423. Since the image processing unit 5409 is configured to perform only requisite minimum processing, the image processing unit 5409 may be realized with a smaller size and lower power consumption, so that this is preferable as the capsule endoscope 5401. However, in a case where there is an extra space in the casing 5403 and extra power consumption, it is possible to perform further signal processing (for example, noise removal processing, other high image quality processing and the like) in the image processing unit 5409. The image processing unit 5409 provides the image signal subjected to the signal processing to the wireless communication unit 5411 as RAW data. Note that, in a case where information regarding a state (movement, attitude and the like) of the capsule endoscope 5401 is obtained by the state detection unit 5419, the image processing unit 5409 may provide the image signal to the wireless communication unit 5411 in association with the information. Therefore, it is possible to associate a position in the body in which the image is imaged, an imaging direction of the image and the like with the imaged image.

The wireless communication unit 5411 includes a communication device capable of transmitting/receiving various types of information to/from the external control device 5423. The communication device includes an antenna 5413, a processing circuit for performing modulation processing and the like for transmitting and receiving signals and the like. The wireless communication unit 5411 performs predetermined processing such as modulation processing on the image signal subjected to the signal processing by the image processing unit 5409 and transmits the image signal to the external control device 5423 via the antenna 5413. Furthermore, the wireless communication unit 5411 receives a control signal regarding drive control of the capsule endoscope 5401 from the external control device 5423 via the antenna 5413. The wireless communication unit 5411 provides the received control signal to the control unit 5421.

The power feed unit 5415 includes an antenna coil for power reception, a power regeneration circuit for regenerating electric power from current generated in the antenna coil, a booster circuit and the like. In the power feed unit 5415, the electric power is generated using a so-called non-contact charging principle. Specifically, a magnetic field (electromagnetic wave) of a predetermined frequency is externally given to the antenna coil of the power feed unit 5415, so that induced electromotive force is generated in the antenna coil. The electromagnetic wave may be a carrier wave transmitted from the external control device 5423 via an antenna 5425, for example. The electric power is regenerated from the induced electromotive force by the power regeneration circuit, and electric potential thereof is appropriately adjusted in the booster circuit, so that electric power for storage is generated. The electric power generated by the power feed unit 5415 is stored in the power supply unit 5417.

The power supply unit 5417 includes a secondary battery and stores the electric power generated by the power feed unit 5415. In FIG. 22, for the sake of simplicity of the drawing, arrows and the like indicating a supply destination of the electric power from the power supply unit 5417 are not illustrated; however, the electric power stored in the power supply unit 5417 is supplied to the light source unit 5405, the imaging unit 5407, the image processing unit 5409, the wireless communication unit 5411, the state detection unit 5419, and the control unit 5421, and may be used for driving them.

The state detection unit 5419 includes a sensor for detecting the state of the capsule endoscope 5401 such as an acceleration sensor and/or a gyro sensor. The state detection unit 5419 may obtain the information regarding the state of the capsule endoscope 5401 from a detection result by the sensor. The state detection unit 5419 provides the obtained information regarding the state of the capsule endoscope 5401 to the image processing unit 5409. As described above, in the image processing unit 5409, the information regarding the state of the capsule endoscope 5401 may be associated with the image signal.

The control unit 5421 includes a processor such as a CPU, and comprehensively controls an operation of the capsule endoscope 5401 by operating according to a predetermined program. The control unit 5421 appropriately controls drive of the light source unit 5405, the imaging unit 5407, the image processing unit 5409, the wireless communication unit 5411, the power feed unit 5415, the power supply unit 5417, and the state detection unit 5419 according to the control signal transmitted from the external control device 5423, thereby realizing the function in each unit as described above.

The external control device 5423 may be a microcomputer, a control board or the like on which a processor such as a CPU and a GPU is mounted, or the processor and a storage element such as a memory are mixedly mounted. The external control device 5423 includes the antenna 5425 and is configured to be able to transmit and receive various types of information to and from the capsule endoscope 5401 via the antenna 5425. Specifically, the external control device 5423 controls the operation of the capsule endoscope 5401 by transmitting the control signal to the control unit 5421 of the capsule endoscope 5401. For example, an irradiation condition of the light to the observation target in the light source unit 5405 might be changed by the control signal from the external control device 5423. Furthermore, an imaging condition (for example, a frame rate, exposure value and the like in the imaging unit 5407) might be changed by the control signal from the external control device 5423. Furthermore, a content of the processing in the image processing unit 5409 and a condition (for example, a transmission interval, the number of transmitted images and the like) for the wireless communication unit 5411 to transmit the image signal may be changed by the control signal from the external control device 5423.

Furthermore, the external control device 5423 applies various types of image processing to the image signal transmitted from the capsule endoscope 5401 and generates the image data for displaying the imaged in-vivo image on the display device. As the image processing, for example, various types of well-known signal processing such as development processing (demosaic processing), high image quality processing (such as band enhancement processing, super-resolution processing, noise reduction (NR) processing, and/or camera shake correction processing), and/or scaling processing (electronic zoom processing) may be performed. The external control device 5423 controls drive of the display device (not illustrated) to display the in-vivo image imaged on the basis of the generated image data. Alternatively, the external control device 5423 may allow a recording device (not illustrated) to record the generated image data or allow a printing device (not illustrated) to print out the same.

An example of the in-vivo information obtaining system 5400 to which the technology according to the present disclosure may be applied is described above. The technology according to the present disclosure may be preferably applied to the capsule endoscope 5401 out of the configurations described above. Specifically, this is applicable to an imaging lens in the capsule endoscope 5401 and the capsule endoscope 5401 provided with the imaging lens. Since a clearer surgical site image may be obtained by applying the technology according to the present disclosure to the capsule endoscope 5401, the accuracy of the examination may be improved and the capsule endoscope 5401 may be made further smaller, so that a burden on the patient may be further reduced.

### Application Example 2

The technology according to the present disclosure may be applied to various products. For example, the technology according to the present disclosure is applicable to an imaging device or an imaging lens mounted on any type of mobile body such as an automobile, an electric automobile, a hybrid electric automobile, a motorcycle, a bicycle, a personal mobility, an airplane, a drone, a ship, a robot, a constructing machine, and an agriculture machine (tractor).

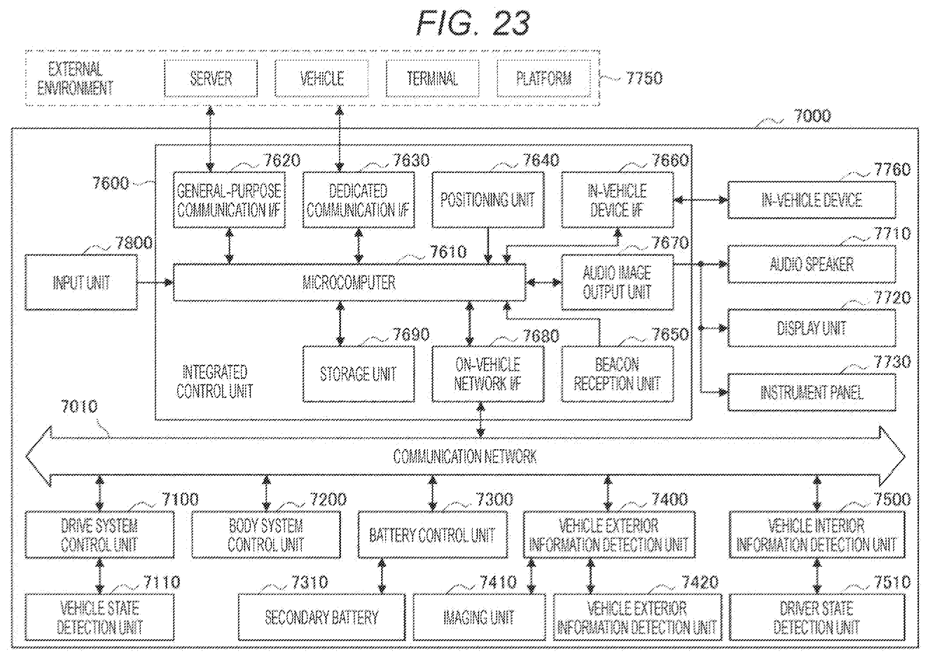

FIG. 23 is a block diagram illustrating a schematic configuration example of a vehicle control system 7000 that is an example of a mobile body control system to which the technology according to the present disclosure may be applied. The vehicle control system 7000 is provided with a plurality of electronic control units connected to one another via a communication network 7010. In the example illustrated in FIG. 23, the vehicle control system 7000 is provided with a drive system control unit 7100, a body system control unit 7200, a battery control unit 7300, a vehicle exterior information detection unit 7400, a vehicle interior information detection unit 7500, and an integrated control unit 7600. The communication network 7010 that connects the plurality of control units may be an on-vehicle communication network compliant with any standard of the controller area network (CAN), local interconnect network (LIN), local area network (LAN), FlexRay (registered trademark) or the like, for example.

Each control unit is provided with a microcomputer that performs arithmetic processing according to various programs, a storage unit that stores the programs executed by the microcomputer, parameters used for various arithmetic operations and the like, and a drive circuit that drives various devices to be controlled. Each control unit is provided with a network I/F for communicating with other control units via the communication network 7010, and a communication I/F for communicating by wired communication or wireless communication with devices, sensors or the like inside and outside the vehicle. In FIG. 23, as a functional configuration of the integrated control unit 7600, a microcomputer 7610, a general-purpose communication I/F 7620, a dedicated communication I/F 7630, a positioning unit 7640, a beacon reception unit 7650, an in-vehicle device I/F 7660, an audio image output unit 7670, an on-vehicle network I/F 7680, and a storage unit 7690 are illustrated. Other control units are similarly provided with a microcomputer, a communication I/F, a storage unit and the like.

The drive system control unit 7100 controls an operation of a device related to a drive system of a vehicle according to various programs. For example, the drive system control unit 7100 serves as a control device of a driving force generating device for generating driving force of the vehicle such as an internal combustion engine, a driving motor or the like, a driving force transmitting mechanism for transmitting the driving force to wheels, a steering mechanism that adjusts a rudder angle of the vehicle, a braking device that generates braking force of the vehicle and the like. The drive system control unit 7100 may have a function as a control device of an antilock brake system (ABS), electronic stability control (ESC) or the like.

A vehicle state detection unit 7110 is connected to the drive system control unit 7100. The vehicle state detection unit 7110 includes, for example, a gyro sensor that detects an angular velocity of axial rotational movement of a vehicle body, an acceleration sensor that detects acceleration of the vehicle, or at least one of sensors for detecting an operation amount of an accelerator pedal, an operation amount of a brake pedal, a steering angle of a steering wheel, an engine speed, a wheel rotational speed or the like. The drive system control unit 7100 performs arithmetic processing using a signal input from the vehicle state detection unit 7110 to control the internal combustion engine, the driving motor, an electric power steering device, a brake device or the like.

The body system control unit 7200 controls operations of various devices mounted on the vehicle body in accordance with various programs. For example, the body system control unit 7200 serves as a control device of a keyless entry system, a smart key system, a power window device, or various lights such as a head light, a backing light, a brake light, a blinker, a fog light or the like. In this case, a radio wave transmitted from a portable device that substitutes for a key or signals of various switches may be input to the body system control unit 7200. The body system control unit 7200 receives an input of the radio wave or signals and controls a door lock device, the power window device, the lights and the like of the vehicle.

The battery control unit 7300 controls a secondary battery 7310 that is a power supply source of the driving motor according to various programs. For example, information such as battery temperature, a battery output voltage, or remaining battery capacity is input to the battery control unit 7300 from the battery device provided with the secondary battery 7310. The battery control unit 7300 performs arithmetic processing using these signals, and controls temperature adjustment of the secondary battery 7310 or a cooling device and the like provided in the battery device.

The vehicle exterior information detection unit 7400 detects information outside the vehicle on which the vehicle control system 7000 is mounted. For example, the vehicle exterior information detection unit 7400 is connected to at least one of an imaging unit 7410 or a vehicle exterior information detection unit 7420. The imaging unit 7410 includes at least one of a time of flight (ToF) camera, a stereo camera, a monocular camera, an infrared camera, or other cameras. The vehicle exterior information detection unit 7420 includes, for example, at least one of an environmental sensor for detecting current weather or meteorological phenomenon, or an ambient information detection sensor for detecting other vehicles, obstacles, pedestrians or the like around the vehicle on which the vehicle control system 7000 is mounted.

The environmental sensor may be, for example, at least one of a raindrop sensor that detects rainy weather, a fog sensor that detects fog, a sunshine sensor that detects sunlight intensity, or a snow sensor that detects snowfall. The ambient information detection sensor may be at least one of an ultrasonic sensor, a radar device, or light detection and ranging, laser imaging detection and ranging (LIDAR) device. The imaging unit 7410 and the vehicle exterior information detection unit 7420 may be provided as independent sensors or devices, or may be provided as a device in which a plurality of sensors or devices is integrated.

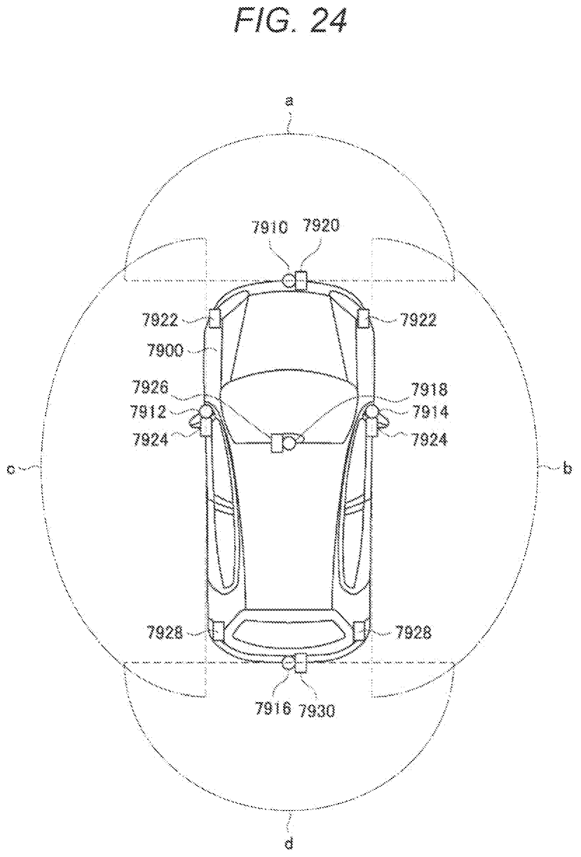

Here, FIG. 24 illustrates an example of installation positions of the imaging unit 7410 and the vehicle exterior information detection unit 7420. Each of imaging units 7910, 7912, 7914, 7916, and 7918 is arranged in at least one position of a front nose, a side mirror, a rear bumper, a rear door, and an upper portion of a windshield in a vehicle interior of the vehicle 7900, for example. The imaging unit 7910 provided on the front nose and the imaging unit 7918 provided in the upper portion of the windshield in the vehicle interior principally obtain images in front of the vehicle 7900. The imaging units 7912 and 7914 provided on the side mirrors principally obtain images of the sides of the vehicle 7900. The imaging unit 7916 provided on the rear bumper or the rear door principally obtains an image behind the vehicle 7900. The imaging unit 7918 provided in the upper portion of the windshield in the vehicle interior is principally used for detecting a preceding vehicle, a pedestrian, an obstacle, a traffic signal, a traffic sign, a lane or the like.

Note that, in FIG. 24, an example of imaging ranges of the imaging units 7910, 7912, 7914, and 7916 is illustrated. An imaging range a indicates the imaging range of the imaging unit 7910 provided on the front nose, imaging ranges b and c indicate the imaging ranges of the imaging units 7912 and 7914 provided on the side mirrors, and an imaging range d indicates the imaging range of the imaging unit 7916 provided on the rear bumper or rear door. For example, image data imaged by the imaging units 7910, 7912, 7914, and 7916 are superimposed, so that an overlooking image of the vehicle 7900 as seen from above is obtained.

Vehicle exterior information detection units 7920, 7922, 7924, 7926, 7928, and 7930 provided on front, rear, side, corner, and the upper portion of the windshield of the vehicle interior of the vehicle 7900 may be ultrasonic sensors or radar devices, for example. The vehicle exterior information detection units 7920, 7926, and 7930 provided on the front nose, the rear bumper, the rear door, and the upper portion of the windshield in the vehicle interior of the vehicle 7900 may be, for example, the LIDAR devices. These vehicle exterior information detection units 7920 to 7930 are principally used for detecting the preceding vehicle, the pedestrian, the obstacle or the like.

Returning to FIG. 23, the description is continued. The vehicle exterior information detection unit 7400 allows the imaging unit 7410 to image an image outside the vehicle and receives imaged image data. Furthermore, the vehicle exterior information detection unit 7400 receives detection information from the vehicle exterior information detection unit 7420 connected thereto. In a case where the vehicle exterior information detection unit 7420 is the ultrasonic sensor, the radar device, or the LIDAR device, the vehicle exterior information detection unit 7400 transmits ultrasonic waves, electromagnetic waves or the like, and receives information of received reflected wave. The vehicle exterior information detection unit 7400 may perform detection processing of objects such as a person, a vehicle, an obstacle, a sign, or a character on a road surface or distance detection processing on the basis of the received image. The vehicle exterior information detection unit 7400 may perform environment recognition processing for recognizing rainfall, fog, road surface conditions or the like on the basis of the received information. The vehicle exterior information detection unit 7400 may calculate a distance to an object outside the vehicle on the basis of the received information.

Furthermore, the vehicle exterior information detection unit 7400 may perform image recognition processing of recognizing a person, a vehicle, an obstacle, a sign, a character on a road surface or the like or distance detection processing on the basis of the received image. The vehicle exterior information detection unit 7400 may perform processing such as distortion correction or alignment on the received image data, and combine the image data imaged by different imaging units 7410 to generate an overlooking image or a panoramic image. The vehicle exterior information detection unit 7400 may perform viewpoint conversion processing using the image data imaged by the different imaging units 7410.

The vehicle interior information detection unit 7500 detects information in the vehicle. The vehicle interior information detection unit 7500 is connected to, for example, a driver state detection unit 7510 for detecting a state of a driver. The driver state detection unit 7510 may include a camera that images the driver, a biometric sensor that detects biometric information of the driver, a microphone that collects sound in the vehicle interior or the like. The biometric sensor is provided, for example, on a seat surface, a steering wheel or the like, and detects biometric information of a passenger sitting on the seat or the driver holding the steering wheel. The vehicle interior information detection unit 7500 may calculate a driver's fatigue level or concentration level or may determine whether the driver is not dozing on the basis of detection information input from the driver state detection unit 7510. The vehicle interior information detection unit 7500 may perform processing such as noise canceling processing on the collected audio signal.

The integrated control unit 7600 controls the overall operation in the vehicle control system 7000 according to various programs. An input unit 7800 is connected to the integrated control unit 7600. The input unit 7800 is realized by a device that may be operated by the passenger to input, such as a touch panel, a button, a microphone, a switch, or a lever, for example. To the integrated control unit 7600, data obtained by audio recognition of audio input by the microphone may be input. The input unit 7800 may be, for example, a remote control device using infrared rays or other radio waves, or may be an external connection device such as a mobile phone or a personal digital assistant (PDA) that supports the operation of the vehicle control system 7000. The input unit 7800 may be, for example, a camera, and in that case, the passenger may input information by gesture. Alternatively, data obtained by detecting movement of a wearable device worn by the passenger may be input. Moreover, the input unit 7800 may include, for example, an input control circuit and the like that generates an input signal on the basis of the information input by the passenger and the like using the input unit 7800 described above and outputs to the integrated control unit 7600. The passenger and the like operate the input unit 7800 to input various data to the vehicle control system 7000 or indicate a processing operation.

The storage unit 7690 may include a read only memory (ROM) that stores various programs executed by the microcomputer, and a random access memory (RAM) that stores various parameters, operation results, sensor values or the like. Furthermore, the storage unit 7690 may be realized by a magnetic storage device such as a hard disc drive (HDD), a semiconductor storage device, an optical storage device, a magneto-optical storage device or the like.

The general-purpose communication I/F 7620 is a general-purpose communication I/F that mediates communication with various devices present in an external environment 7750. The general-purpose communication I/F 7620 may implement a cellular communication protocol such as global system of mobile communications (GSM (registered trademark)), WiMAX (registered trademark), long term evolution (LTE (registered trademark)), or LTE-advanced (LTE-A), or other wireless communication protocols such as wireless LAN (also referred to as Wi-Fi (registered trademark)), Bluetooth (registered trademark) and the like. The general-purpose communication I/F 7620 may be connected to a device (for example, an application server or a control server) present on an external network (for example, the Internet, a cloud network, or an operator-specific network) via, for example, a base station or an access point. Furthermore, the general-purpose communication I/F 7620 may use, for example, a peer to peer (P2P) technology to connect to a terminal present in the vicinity of the vehicle (for example, a driver, a pedestrian or a store terminal, or a machine type communication (MTC) terminal.

The dedicated communication I/F 7630 is a communication I/F that supports a communication protocol planned for use in a vehicle. The dedicated communication I/F 7630 may implement standard protocols such as wireless access in vehicle environment (WAVE) that is a combination of lower-layer IEEE802.11p and upper-layer IEEE1609, dedicated short range communications (DSRC), or cellular communication protocol, for example. The dedicated communication I/F 7630 typically executes V2X communication being a concept including one or more of vehicle-to-vehicle communication, vehicle-to-infrastructure communication, vehicle-to-home communication, and vehicle-to-pedestrian communication.

The positioning unit 7640 receives a GNSS signal from a global navigation satellite system (GNSS) satellite (for example, a GPS signal from a global positioning system (GPS) satellite) to execute positioning, and generates positional information including the latitude, longitude, and altitude of the vehicle, for example. Note that, the positioning unit 7640 may specify a current position by exchanging signals with the wireless access point, or may obtain the positional information from a terminal such as a mobile phone, PHS, or smartphone having a positioning function.

For example, the beacon reception unit 7650 receives radio waves or electromagnetic waves transmitted from a wireless station and the like installed on the road, and obtains information such as the current position, traffic jam, closed road, or required time. Note that, the function of the beacon reception unit 7650 may be included in the dedicated communication I/F 7630 described above.

The in-vehicle device I/F 7660 is a communication interface that mediates connections between the microcomputer 7610 and various in-vehicle devices 7760 present in the vehicle. The in-vehicle device I/F 7660 may establish a wireless connection using a wireless communication protocol such as wireless LAN, Bluetooth (registered trademark), near field communication (NFC), or wireless USB (WUSB). Furthermore, the in-vehicle device I/F 7660 may establish a wired connection such as universal serial bus (USB), high-definition multimedia interface (HDMI (registered trademark)), or mobile high-definition link (MHL) via a connection terminal (and a cable if necessary) not illustrated. The in-vehicle devices 7760 may include, for example, at least one of a mobile device or a wearable device that the passenger has, or an information device carried in or attached to the vehicle. Furthermore, the in-vehicle devices 7760 may include a navigation device that searches for a route to an arbitrary destination. The in-vehicle device I/F 7660 exchanges control signals or data signals with these in-vehicle devices 7760.

The on-vehicle network I/F 7680 is an interface that mediates communication between the microcomputer 7610 and the communication network 7010. The on-vehicle network I/F 7680 transmits and receives signals and the like in accordance with a predetermined protocol supported by the communication network 7010.

The microcomputer 7610 of the integrated control unit 7600 controls the vehicle control system 7000 according to various programs on the basis of information obtained via at least one of the general-purpose communication I/F 7620, the dedicated communication I/F 7630, the positioning unit 7640, the beacon reception unit 7650, the in-vehicle device I/F 7660, or the on-vehicle network I/F 7680. For example, the microcomputer 7610 may calculate a control target value of the driving force generating device, the steering mechanism, or the braking device on the basis of the obtained information inside and outside the vehicle and output a control instruction to the drive system control unit 7100. For example, the microcomputer 7610 may perform cooperative control for realizing functions of advanced driver assistance system (ADAS) including collision avoidance or impact attenuation of the vehicle, following travel based on the distance between the vehicles, vehicle speed maintaining travel, vehicle collision warning, vehicle lane departure warning or the like. Furthermore, the microcomputer 7610 may perform the cooperative control for realizing automatic driving and the like to autonomously travel independent from the operation of the driver by controlling the driving force generating device, the steering mechanism, the braking device or the like on the basis of the obtained information around the vehicle.

The microcomputer 7610 may generate three-dimensional distance information between the vehicle and objects such as peripheral structure and person on the basis of information obtained via at least one of the general-purpose communication I/F 7620, the dedicated communication I/F 7630, the positioning unit 7640, the beacon reception unit 7650, the in-vehicle device I/F 7660, or the on-vehicle network I/F 7680 to create local map information including peripheral information of the current position of the vehicle. Furthermore, the microcomputer 7610 may generate a warning signal by predicting a danger such as vehicle collision, approach of a pedestrian and the like or entry to a closed road on the basis of the obtained information. The warning signal may be, for example, a signal for generating a warning sound or lighting a warning light.

The audio image output unit 7670 transmits at least one of audio or image output signal to an output device capable of visually or audibly notifying the passenger of the vehicle or the outside the vehicle of the information. In the example in FIG. 23, as the output device, an audio speaker 7710, a display unit 7720, and an instrument panel 7730 are illustrated. The display unit 7720 may include at least one of an on-board display or a head-up display, for example. The display unit 7720 may have an augmented reality (AR) display function. In addition to these devices, the output device may be other devices such as a headphone, a wearable device such as an eyeglass-type display worn by the passenger, a projector, or light. In a case where the output device is the display device, the display device visually displays results obtained by various types of processing performed by the microcomputer 7610 or information received from other control units in various formats such as text, image, table, and graph. Furthermore, in a case where the output device is an audio output device, the audio output device converts an audio signal including reproduced audio data, acoustic data or the like into an analog signal and aurally outputs the same.

Note that, in the example illustrated in FIG. 23, at least two control units connected via the communication network 7010 may be integrated as one control unit. Alternatively, each control unit may be configured by a plurality of control units. Moreover, the vehicle control system 7000 may be provided with another control unit not illustrated. Furthermore, in the above description, a part of or all of the functions of any of the control units may be assigned to other control units. That is, as long as information is transmitted and received via the communication network 7010, predetermined arithmetic processing may be performed by any control unit. Similarly, a sensor or a device connected to any control unit may be connected to another control unit, and a plurality of control units may transmit/receive detection information to/from each other via the communication network 7010.

### [Present Technology]

The present technology may also have the following configuration.

<1>

An imaging lens provided with:

a first lens having a positive refractive power with a convex surface facing an object side;

a second lens having a positive refractive power;

a third lens having a negative refractive power;

a fourth lens having a positive refractive power or a negative refractive power with a concave surface facing the object side;

a fifth lens having a positive refractive power or a negative refractive power;

a sixth lens having a positive refractive power with a concave surface facing an image side; and

a seventh lens having a negative refractive power in a vicinity of an optical axis, a surface on the image side of which is formed into an aspherical shape having an inflection point,

in order from the object side to the image side.

<2>

The imaging lens according to <1>

that satisfies following conditional expression (1):

1.0<f1/f<225.0 (1)

where

f is a focal length of an entire system, and

f1 is a focal length of the first lens.

<3>

The imaging lens according to <1> or <2>

that satisfies following conditional expression (2):

0.7<f2/f<4.0 (2)

where

f is a focal length of an entire system, and

f2 is a focal length of the second lens.

<4>

The imaging lens according to any one of <1> to <3>

that satisfies following conditional expression (3):

4.0<|f45|/f (3)

where

f is a focal length of an entire system, and

f45 is a composite focal length of the fourth and fifth lenses.

<5>

The imaging lens according to any one of <1> to <4>

that satisfies following conditional expression (4):

2.8<f6/f<215.0 (4)

where

f is a focal length of an entire system, and

f6 is a focal length of the sixth lens.

<6>

The imaging lens according to any one of <1> to <5>

that satisfies following conditional expression (5):

−46.0<f6/f7<−0.3 (5)

where

f6 is a focal length of the sixth lens, and

f7 is a focal length of the seventh lens.

<7>

The imaging lens according to any one of <1> to <6>

that satisfies following conditional expression (6):

5.4<|R7/f|<220.0 (6)

where

f is a focal length of an entire system, and

R7 is a curvature radius of a surface on the object side of the fourth lens.

<8>

The imaging lens according to any one of <1> to <7>

that satisfies following conditional expression (7):

5.8<|(R11+R12)/(R11−R12)|<320.0 (7)

where

R11 is a curvature radius of a surface on the object side of the sixth lens, and

R12 is a curvature radius of a surface on the image side of the sixth lens.

<9>

The imaging lens according to any one of <1> to <8>

that satisfies following conditional expression (8):

18.0<νd(L3)<νd(L5)<νd(L6)<30.0 (8)

where

νd (L3) is an Abbe number on a d-line of the third lens,

νd (L5) is an Abbe number on a d-line of the fifth lens, and

νd (L6) is an Abbe number on a d-line of the sixth lens.

<10>

The imaging lens according to any one of <1> to <9>, in which

an aperture diaphragm is arranged on the object side of the first lens or between the first lens and the second lens.

<11>

The imaging lens according to any one of <1> to <10>, in which

the sixth lens has an inflection point on a surface on the image side.

<12>

An imaging device provided with:

an imaging lens and an imaging element that converts an optical image formed by the imaging lens into an electric signal, in which

the imaging lens is provided with:

a first lens having a positive refractive power with a convex surface facing an object side;

a second lens having a positive refractive power;

a third lens having a negative refractive power;

a fourth lens having a positive refractive power or a negative refractive power with a concave surface facing the object side;

a fifth lens having a positive refractive power or a negative refractive power;

a sixth lens having a positive refractive power with a concave surface facing an image side; and

a seventh lens having a negative refractive power in the vicinity of an optical axis, a surface on the image side of which is formed into an aspherical shape having an inflection point,

in order from the object side to the image side.

### REFERENCE SIGNS LIST

1 Imaging lens
2 Imaging lens
3 Imaging lens
4 Imaging lens
5 Imaging lens
6 Imaging lens
7 Imaging lens
8 Imaging lens
9 Imaging lens
10 Imaging lens
L1 First lens
L2 Second lens
L3 Third lens
L4 Fourth lens
L5 Fifth lens
L6 Sixth lens
L7 Seventh lens
100 Imaging device
10 Imaging element

1. An imaging lens comprising:
a first lens having a positive refractive power with a convex surface facing an object side;
a second lens having a positive refractive power;
a third lens having a negative refractive power;
a fourth lens having a positive refractive power or a negative refractive power with a concave surface facing the object side;
a fifth lens having a positive refractive power or a negative refractive power;
a sixth lens having a positive refractive power with a concave surface facing an image side; and
a seventh lens having a negative refractive power in a vicinity of an optical axis, a surface on the image side of which is formed into an aspherical shape having an inflection point,
in order from the object side to the image side.

2. The imaging lens according to claim 1
that satisfies following conditional expression (1):
1.0<f1/f<225.0 (1)
where
f is a focal length of an entire system, and
f1 is a focal length of the first lens.

3. The imaging lens according to claim 1
that satisfies following conditional expression (2):
0.7<f2/f<4.0 (2)
where
f is a focal length of an entire system, and
f2 is a focal length of the second lens.

4. The imaging lens according to claim 1
that satisfies following conditional expression (3):
4.0<|f45|/f (3)
where
f is a focal length of an entire system, and
f45 is a composite focal length of the fourth and fifth lenses.

5. The imaging lens according to claim 1
that satisfies following conditional expression (4):
2.8<f6/f<215.0 (4)
where
f is a focal length of an entire system, and
f6 is a focal length of the sixth lens.

6. The imaging lens according to claim 1
that satisfies following conditional expression (5):
−46.0<f6/f7<−0.3 (5)
where
f6 is a focal length of the sixth lens, and
f7 is a focal length of the seventh lens.

7. The imaging lens according to claim 1
that satisfies following conditional expression (6):
5.4<|R7/f|<220.0 (6)
where
f is a focal length of an entire system, and
R7 is a curvature radius of a surface on the object side of the fourth lens.

8. The imaging lens according to claim 1
that satisfies following conditional expression (7):
5.8<|(R11+R12)/(R11−R12)|<320.0 (7)
where
R11 is a curvature radius of a surface on the object side of the sixth lens, and
R12 is a curvature radius of a surface on the image side of the sixth lens.

9. The imaging lens according to claim 1
that satisfies following conditional expression (8):
18.0<νd(L3)<νd(L5)<νd(L6)<30.0 (8)
where
νd(L3) is an Abbe number on a d-line of the third lens,
νd(L5) is an Abbe number on a d-line of the fifth lens, and
νd(L6) is an Abbe number on a d-line of the sixth lens.

10. The imaging lens according to claim 1, wherein
an aperture diaphragm is arranged on the object side of the first lens or between the first lens and the second lens.

11. The imaging lens according to claim 1, wherein
the sixth lens has an inflection point on a surface on the image side.

12. An imaging device comprising:
an imaging lens and an imaging element that converts an optical image formed by the imaging lens into an electric signal, wherein
the imaging lens is provided with:
a first lens having a positive refractive power with a convex surface facing an object side;
a second lens having a positive refractive power;
a third lens having a negative refractive power;
a fourth lens having a positive refractive power or a negative refractive power with a concave surface facing the object side;
a fifth lens having a positive refractive power or a negative refractive power;
a sixth lens having a positive refractive power with a concave surface facing an image side; and
a seventh lens having a negative refractive power in a vicinity of an optical axis, a surface on the image side of which is formed into an aspherical shape having an inflection point,
in order from the object side to the image side.
